(19) United States
(12) Patent Application Publication
(10) Pub. No.: US 2013/0036023 A1
(43) Pub. Date: Feb. 7, 2013

(54) System And Method For Facilitating A Transaction Between An Enterprise And A Person Using A Mobile Device

(71) Applicants: David E. Koplovitz, Coral Springs, FL (US); Jeremy R. Martin, Boca Raton, FL (US)

(72) Inventors: David E. Koplovitz, Coral Springs, FL (US); Jeremy R. Martin, Boca Raton, FL (US)

(73) Assignee: 3C INTERACTIVE LLC, Boca Raton, FL (US)

(21) Appl. No.: 13/491,632

(22) Filed: Jun. 8, 2012

Related U.S. Application Data
(60) Provisional application No. 61/515,052, filed on Aug. 4, 2011.

(51) Int. Cl. G06Q 20/32; G06Q 30/06

(52) U.S. Cl. 705/26.8; 705/39

(57) ABSTRACT

A system and method for a transaction between a person using a mobile device and an enterprise is disclosed. A computing system, application program interface, and data storage, and network connectivity is provided. Data files can be presented to the mobile device. A system and method for conducting a transaction structured between a merchant and a customer with a mobile device involving the interchange of information is also disclosed. Data is presented to the mobile device of the customer by a push notification, messaging, text messaging, SMS, multimedia messaging, MMS, internet communication, mobile web communication, mWeb, application program communication, mobile application program, mApp, electronic mail and/or e-mail. The transaction may comprise a session; session data is available for a specified use or time. Information may comprise personally-identifiable information (PH), private health-care information (PHI), private credit information (PCI) and/or enterprise secure data (ESD).

The present application incorporates by reference and claims the benefit of priority of U.S. provisional patent application Ser. No. 61/515,052, filed Aug. 4, 2011.

### FIELD

The present invention relates to a system and method for conducting an interaction or transaction between an enterprise and a person using a mobile device. The present invention also relates to system and method for conducting an interaction or transaction that is structured and/or facilitated by a facilitator between an enterprise and a person such as a customer and/or consumer with a mobile device. The present invention also relates to system and method for conducting a transaction that is structured and/or facilitated by a facilitator between an enterprise and a customer with a mobile device involving the interchange of at least a first set of information and a second set of information between the enterprise and the customer. The system and method can be structured so that the transaction can be conducted without the facilitator receiving the second set of information (which may contain private or personal information of a customer). The system and method can be facilitated to operate over at least one communication channel.

### BACKGROUND

It is well-known for persons (such as consumers, customers and potential customers, collectively referred to as “consumer” or “customer”) to interact and transact with enterprises (such as merchants and service providers) over communications channels and networks such as the internet. It is also known for consumers to use mobile devices (e.g. smart phones, cellular telephones, tablet computers, or other networked/computing devices) for conducting such interactions and transactions.

The ability and willingness of persons such as consumers to use mobile devices for interactions and transactions with enterprises has created opportunities for enterprises to grow and profit. The opportunities continue to expand with the growth in the number of persons having mobile devices, growth in the scope and capability of the networks over which such mobile devices operate (e.g. digital and wireless/cellular communication channels and networks), and growth in the capabilities of the mobile devices themselves, among other things. As the number and types of mobile devices in use expands, the number of people who interact and/or transact through mobile devices and the frequency in which they interact and transact through mobile devices will expand. For example, interactions and transactions that may have been conducted by persons from home computers are more frequently being conducted using mobile devices; communications that may have been exchanged through e-mail on a computer may now be exchanged by messaging on a mobile device (e.g. SMS/text or MMS or “push notification” in some manner/over some channel); potential customers who visited the website of an enterprise on a home computer may now be visiting the website from their mobile device. The growing number and wide variety of mobile devices and the manner in which persons use the mobile devices present challenges for enterprises. For enterprises that wish to grow and prosper, the ability to establish and maintain effective contact with persons using mobile devices (e.g. mobile customers) may be an important business consideration, notwithstanding the challenges.

It is known that in the interaction and transaction between persons with mobile devices and enterprises such as merchants various items and sets of information are exchanged. For example, when a consumer makes a purchase of an item or service from a merchant, the consumer will provide a name/address and payment information (such as a credit card number and security/validation codes). Such information is sometimes stored by an enterprise (for the convenience of the person for use in future transactions) or deleted by an enterprise (perhaps in full or in some part, for the security of the information) after the interaction or transaction.

Certain information of a person is considered to be personal and/or or private and the unauthorized use or possession of such information may be restricted or regulated by law. Certain information relating to a person may be used or combined with other information to establish knowledge about the person such that the privacy or identity of the person may be compromised. Information of a person may be considered (e.g. from an administrative or regulatory standpoint) personal or private notwithstanding the willingness of a person to use or share the information (and notwithstanding the willingness of the person to share the information without exercising reasonable protections of their own). As indicated, a person is required to share certain combinations of information to transact business with enterprises.

The use of information in interactions or transactions may expose a person to potential risk of what is often called “identify theft” or more generally a potential risk that others may conduct unauthorized transactions using personal information that others should not be using or possessing, for example, as in the unauthorized use of a credit card or other financial account, or the unauthorized use of personal information to obtain a credit card (or other account) or in connection with another commercial transaction. For certain types of information, such as health-care related information of a person (e.g. PHI or personal healthcare information), others who obtain the information without authorization may violate the privacy of the person (in a legal and/or practical sense).

The need to protect personal information, including what is considered “personally identifiable information” (PII), has been recognized. In many jurisdictions, certain items and categories of information have been designated as protected under various laws, such as state and federal laws relating to consumer protection or personal privacy (e.g. Health Insurance Portability and Accountability Act or HIPAA). Actual or perceived mishandling of personal information (e.g. PII, PHI, financial information designated as PCI, or other information) may subject an enterprise to various harms and liabilities, including those arising from violations of law and those arising from loss of public confidence and esteem.

Enterprises that use information for transactions may be at risk of potential liability even when they have undertaken good faith measures to protect information received from persons. Laws, regulations and rules relating to personal information are not necessarily consistent among jurisdictions (or agencies/organizations) and may also be subject to difficulties in interpretation. Information that such enterprises have stored in a manner considered to be secure by reasonable standards may be subject to compromise by others who attempt unlawful access (e.g. by “hacking” into computing systems).

Risks relating to personal information may be intensified when interactions or transactions are conducted by persons using mobile devices and/or when information is communicated over a network and shared with other entities (by virtue of the manner of use of mobile devices). Such information may include a wide variety of types and categories, such as relating to personal identity, personal financial, personal health or personal security, etc. (or enterprise/network security). The greater the amount of personal information and/or the greater the number of entities that receive personal information, the greater the risk that there may be a compromise of information security. Enterprises who conduct interactions and transactions with persons using mobile devices necessarily must receive and use personal information, notwithstanding the potential risk.

### SUMMARY

It would be advantageous to have a system and method for facilitating interactions and transactions between consumers using mobile devices and enterprises. It would also be advantageous to have a facilitator with expertise to structure and/or manage the interactions and transactions in a manner that allows enterprises to connect more efficiently and effectively with persons using mobile devices. It would further be advantageous to have a facilitator to structure and/or manage interactions and transactions between persons using mobile devices and enterprises in a manner that addresses potential liabilities that may arise from the sharing of information, including personal/private information. It would further be advantageous to have a system and method for a transaction between a person using a mobile device and an enterprise that was facilitated in a manner to designate a first set of information and a second set of information used for the interaction or transaction but to limit the use of the second set of information (which may comprise personal/private information). It would further be advantageous to have a system and method for a facilitating an interaction or transaction between an enterprise and a person using a mobile device that can be conducted over at least two communication channels.

A system for conducting a transaction that is structured by a facilitator to be conducted between an enterprise and a consumer with a mobile device involving the interchange of a first set of information and a second set of information between the enterprise and the consumer may comprise a computing system operated by the facilitator that is configured to assemble data to the mobile device of the consumer and a network connection configured to transmit the data to be presented on the mobile device of the consumer. The first set of information may comprise information considered personal or private or relating to the consumer; the second set of information may comprise information relating to an account used by the consumer.

The system may comprise a computing system, a network interface to allow communications over a network, and data storage for information. The computing system may comprise a general-purpose computer configured to facilitate interactions and transactions with a mobile device; application programs may operate to configure the computing system to facilitate interactions and transactions using data. Data transmitted from the computing system to the mobile device may provide the capability for the user of the mobile device to conduct a transaction with the enterprise. The computing system may facilitate the transmission of data and files that can be presented on a user interface on the mobile device; data and files may be transmitted from the mobile device to conduct the transaction with the enterprise. The data may comprise the first set of information; the data may also comprise the second set of information. Data from the first set of information may be stored by the facilitator; data storage may be temporary with some portion of the data relating to the interaction being deleted or destroyed after the interaction is concluded. The network interface may comprise a computing device configured to function as a gateway to a network. Information may be presented to the mobile device of the consumer by a message over a communication channel or network. The message may comprise a text message or multi-media message or push notification or may use another type of messaging service. The communication channel may comprise short message service (SMS) or multi-media messaging service (MMS) or some other channel allowing for messaging to a mobile device.

A system may comprise a configuration wherein the message comprises a link to a mobile web page that opens on the mobile device to present a form to be completed by the consumer by the inclusion of the second set of information; and wherein the form comprises a link configured to have the form submitted to the enterprise to facilitate the completion of the transaction so that the facilitator does not receive any of the second set of information. A system may comprise a configuration wherein the message comprises an application that runs a program on the mobile device to present a form to be completed by the consumer by the inclusion of the second set of information; and wherein the form comprises a link configured to have the form submitted to the enterprise to facilitate the completion of the transaction so that the facilitator does not receive any of the second set of information. A system may comprise a configuration wherein the account used by the consumer comprises a credit card account. The system may comprise a configuration wherein the account used by the consumer comprises a bank account. The system may comprise a configuration wherein the first set of information comprises and identifier of the consumer. The system may comprise a configuration wherein the first set of information comprises data maintained by the facilitator to identify the consumer.

A method of conducting a transaction that is structured by a facilitator to be conducted between an enterprise and a consumer with a mobile device involving the interchange of a first set of information and a second set of information between the enterprise and the consumer may comprise receiving a communication from the enterprise to make a communication to the consumer; processing the communication from the enterprise on a computing system to identify at least one consumer; transmitting a communication to the mobile device of the consumer relating to the first set of information; receiving a response from the mobile device of the consumer; reviewing the response from the consumer; providing a communication to the mobile device of the consumer to that is configured to obtain from the consumer a second set of information and to transmit upon approval by the consumer the second set of information to the enterprise to initiate the completion of the transaction; receiving a notification from the enterprise relating to the status of the transaction; transmitting a notification of the status of the transaction to the consumer.

The method may comprise a configuration wherein the first set of information comprises information relating to the consumer. The method may comprise a configuration wherein the second set of information comprises information relating to an account used by the consumer. The method may comprise a configuration wherein the data is presented to the mobile device of the consumer by a text message. The method may comprise a configuration wherein the text message comprises a link to a web page that opens on the mobile device to present a form to be completed by the consumer by the inclusion of the second set of information; and wherein the form comprises a link configured to have the form submitted to the enterprise to facilitate the completion of the transaction so that the facilitator does not receive any of the second set of information. The method may comprise a configuration wherein the account used by the consumer comprises a credit card account. The method may comprise a configuration wherein the account used by the consumer comprises a bank account. The method may comprise a configuration wherein the first set of information comprises an identifier of the consumer. The method may comprise a configuration wherein the first set of information comprises data maintained by the facilitator to identify the consumer.

A system and method for configuring an interaction such as a transaction between a person using a mobile device and an enterprise that can involve a facilitator and a third party entity may comprise a computing system operated by the facilitator; at least one application program interface made available by the facilitator to the third party entity; data storage associated with the computing system for at least temporarily storing data related to the transaction; network connectivity from the computing system to the enterprise, to the third party entity and to the person using the mobile device. The facilitator may provide data files that can be presented to the mobile device for facilitating the transaction; and the facilitator may provide information relating to the transaction to the enterprise after the transaction has been initiated

The interaction or transaction may comprise at least one of (1) a banking transaction; (2) a financial transaction; (3) a wire transfer approval; (4) a payment collection; (5) a purchase; (6) an alert to the customer; (7) registration of the customer; (8) a retail transaction; (9) a transaction related to customer loyalty; (10) a medical transaction; (11) a reminder of an appointment; (12) a test or trial of a medication; (13) a test or trial involving the customer; (14) a notification; (15) a fee collection; (16) a service reminder; (17) a maintenance reminder; (18) a report on an account; (19) a telecommunications service; (20) a hospitality transaction; (21) an entertainment transaction; (22) a travel transaction; (23) a completion of an accommodation; (24) a confirmation of a reservation; (25) a reminder of a reservation; (26) a subscription; (27) a fraud alert; (28) a billing threshold alert; (29) a credit card usage alert; (30) a customer loyalty recognition transaction; (31) a notice of a customer loyalty opportunity; (32) a notice of a transaction that was initiated but that was not completed; (33) a notice of a pending transaction that remains pending; (34) a notice of a shopping cart that contains items to be purchased but that has been abandoned for a specified period of time; (35) a notice of the contents of a shopping cart for a transaction; (36) an account information message; (37) scheduling or rescheduling of an appointment; (38) scheduling of a service; (39) refilling or replenishing an product; (40) transacting with a pharmacy or health care provider; (41) transacting with a service provider; (42) informing of a completed transaction; (43) completion of a service or product available for pick-up or delivery; (44) approval of a wire or other financial transfer; (45) invoice or payment collection; (46) approval of a purchase order; (47) registration and coupon management; (48) subscription reminder; (49) billing information update; (50) medical test or trial reporting; (51) medical patient status reporting; (52) approval of a service; (53) upgrade of a service or purchase; (54) notice or collection or payment of a governmental fee or fine or other amount due; (55) hospitality reservation or status change; (56) request of approval of a transaction; (57) alert of a status change or account activity.

### FIGURES AND TABLES

FIGS. 1A through 1C are schematic diagrams of representative systems that may be used by the system and method according to an exemplary embodiment.

FIG. 2 is a schematic diagram of representative channels of communication that may be used by the system and method according to an exemplary embodiment.

FIGS. 3A through 5D are schematic diagrams of representative systems/technology that may be used by the system and method according to an exemplary embodiment.

FIGS. 6A through 6C are schematic diagrams of interactions/transactions that may be conducted by the system and method according to an exemplary embodiment.

FIG. 7 is a schematic diagram of a transaction that may be conducted by the system and method according to an exemplary embodiment.

FIG. 8 is a schematic diagram of the system and method utilizing an inquiry according to an exemplary embodiment.

FIGS. 9A through 9G are schematic diagrams of sub-processes used by the system and method according to exemplary embodiments.

FIGS. 10A and 10B are schematic diagrams of interactions/transactions that may be conducted by the system and method according to an exemplary embodiment.

FIGS. 11A and 11B are schematic diagrams of interactions/transactions that may be conducted by the system and method according to an exemplary embodiment.

FIGS. 12A through 12C are schematic diagrams of the handling or personally identifiable information by the system and method according to an exemplary embodiment.

FIGS. 13A and 13B are schematic diagrams of transactions that may be conducted by the system and method according to an exemplary embodiment.

FIGS. 14A through 14G are schematic diagrams of interactions/transactions that may be conducted by the system and method according to an exemplary embodiment.

FIG. 15 is a schematic diagram of an interaction/transaction that may be conducted by the system and method according to an exemplary embodiment.

FIGS. 16A through 16E are schematic diagrams of interactions/transactions that may be conducted by the system and method according to an exemplary embodiment.

FIG. 17 is a schematic diagram of an interaction/transaction that may be conducted by the system and method according to an exemplary embodiment.

FIGS. 18A and 18B are schematic diagrams of the functionality of the system and method according to an exemplary embodiment.

FIG. 19 (TABLE 1) is a representative presentation of the categorization and management of information that may be used by the system and method according to an exemplary embodiment.

### DESCRIPTION

Mobile devices such as mobile/cellular telephones, “smart phones”, “super phones”, networked media players, tablets, tablet computers, readers, netbooks, GPS devices, cameras, memory devices/storage, etc. have gained widespread popularity. In many parts of society, mobile devices are becoming ubiquitous. Mobile devices are also becoming more full-featured, including through new features and functions and the combinations of features and functionality (i.e. convergence) within devices. The functionality of certain types of mobile devices is for practical purposes indistinguishable in relevant respects from the functionality of computers and data terminals (i.e. with respect to the ability to send and receive and display information by e-mail or over the web/internet, such as on a web browser). The capabilities of such devices to connect to each other and to other devices and resources through various networks and communication channels are rapidly expanding.

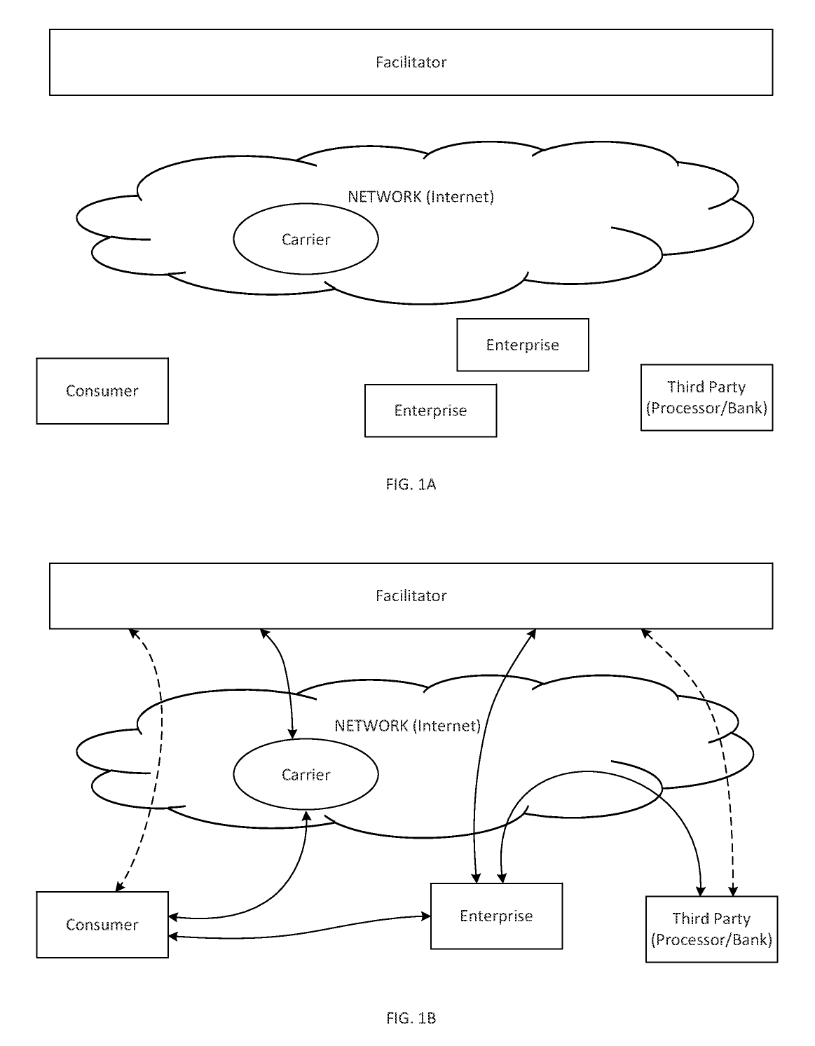

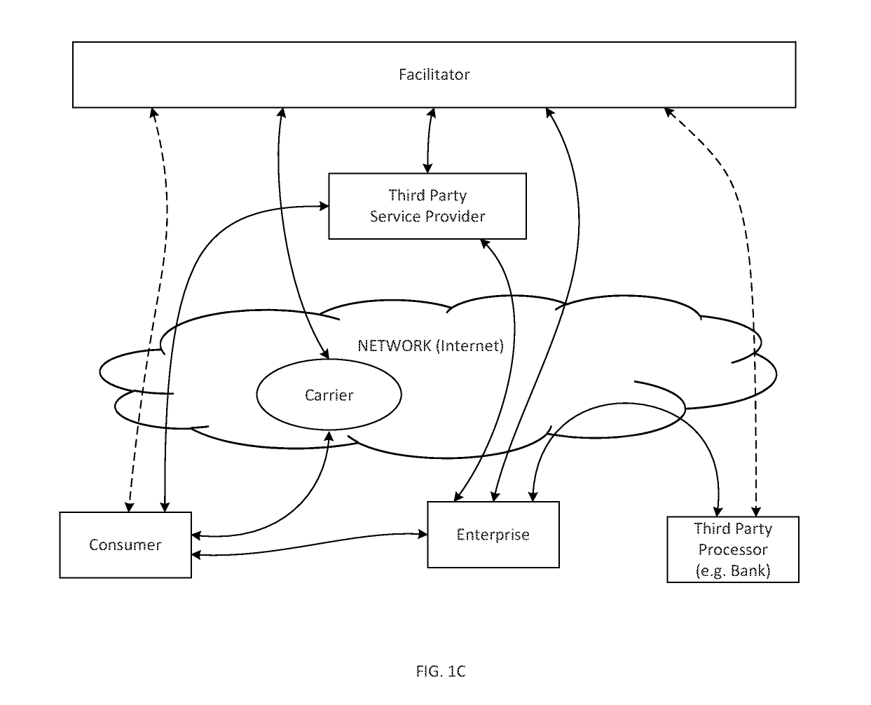

As shown in FIGS. 1A through 1C, for example, through a carrier (e.g. mobile telephone/data service provider) and/or through a network (such as the internet), a mobile device in the hands of a consumer has the capability of establishing communications with enterprises such as merchants to conduct electronic commerce transactions (e.g. using a credit card provided by a bank or financial institution/services provider). As shown in FIG. 1C, transactions and interactions with a consumer on behalf of an enterprise may be assisted in facilitation by a facilitator and/or third-party service provider (capable of performing some or all of the functions of the facilitator).

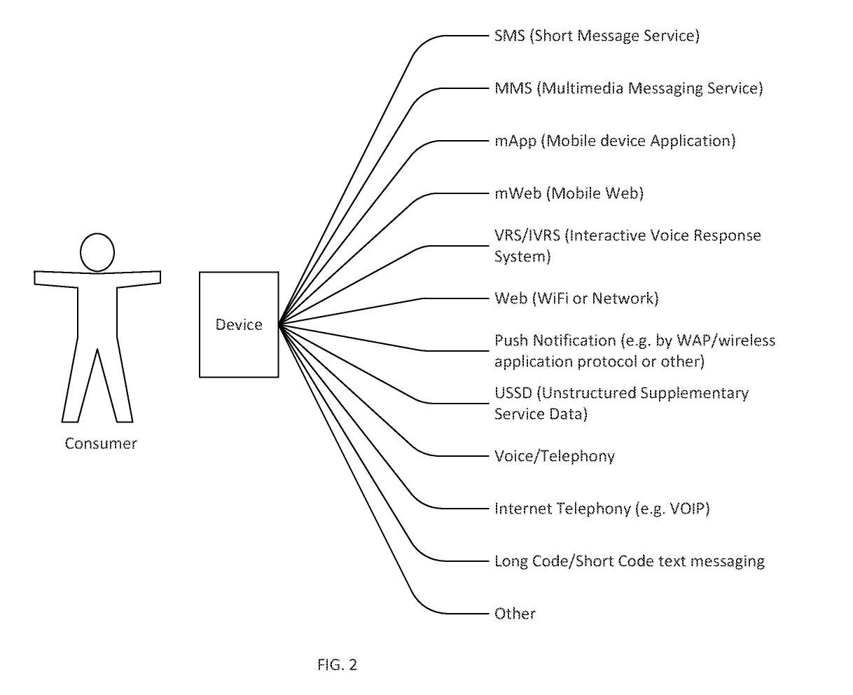

As shown in FIG. 2, for example, a mobile device in the hands of a consumer may have the capability to connect through one or more different channels/networks and types of channels, such as by voice, by voice over internet (VOIP), by the internet (web connectivity through WiFi), by the mobile web (mWeb), by an application program (mApp), by an interactive voice response system (VRS or IVR), by text (SMS or MMS), or by other channels. According to any exemplary embodiment, as shown in FIG. 2, a system and method may employ one channel or multiple channels (i.e. may be “multi-channel”) for communications with the user of a mobile device. According to a preferred embodiment, the system and method may function as a multi-channel facilitation service.

According to any exemplary embodiment, a mobile device may be any of a wide variety or type of devices or apparatuses that a person may use to connect through a communication channel/network, including any type of mobile/cellular telephone, smart phone, tablet, etc. or any other present or future device having communication or networking capability, computing capability with a suitable user interface (e.g. I/O capability) and able to connect to/through a channel/network (e.g. as indicated in FIGS. 1A through 1C), regardless of the name of the device and regardless of any other features, functions, capabilities, enhancements or limitations of the device.

Combinations of features in mobile devices are producing both convergence (single devices that perform multiple functions/features that previously required multiple devices to perform suitably) and the emergence or growth in popularity of new types and categories of devices (e.g. personal/multi-function device such as a tablet computer, such as Apple iPad or Samsung Galaxy/Galaxy Note, Amazon Kindle, etc.) that expand user-available features and functions. For example, a mobile telephone (e.g. smart phone, such as Apple iPhone, Samsung Galaxy Note) may be configured with a camera and GPS (global positioning system) capability; it may have the capability to present and read data such as bar codes. (And of course it will be capable of use as a telephone and likely capable of various other data communications, such as web browsing, e-mail and text messaging, etc.) New mobile device features, functions and enhancements also continue to be developed and implemented as in networked media players such as the Amazon Kindle or other tablet devices/computers such as the Apple iPad, Samsung Galaxy, Lenovo IdeaPad, Herotab, etc. or other such devices.

Among other functions, using technology implemented through service providers or vendor (e.g. AT&T Wireless, Verizon Wireless, T-Mobile, Tracfone, StraightTalk, etc.) or the like (such as a mobile phone service, messaging aggregator, internet service provider, etc.), a consumer with a mobile device can use communications by voice and messages (e.g. SMS/text and MMS messaging), e-mail communications, social media and web browsing, for informational and/or commercial interactions and transactions. Persons with mobile devices are able to stay “connected” virtually anywhere that a communication service is available (e.g. transmit/receive signals from carrier by sharing/using network access in some manner).

Mobile devices in the hands of consumers (collectively if not individually) are put to multiple uses and have widely varying capabilities. In some instances, individual mobile devices may be equipped with multiple means of establishing connectivity to a network—e.g. via a cellular telephone connection, via a voice gateway/VOIP, via a Wi-Fi connection, via a Bluetooth connection, via a carrier-specific connection, etc. (In some instances, certain consumers may also wish to use other types of computing devices to effect the same or similar operations as they do on their mobile devices, or use their mobile device as a means to connect a computing device to a network.) In the hands of any particular consumer, a particular mobile device may be used in a different manner than is an identical mobile device in the hands of a different consumer. The use of mobile devices varies not only in relation to the capabilities of the particular device but also the needs and preferences of the consumer using the device.

According to any exemplary embodiment, an enterprise may be any of a wide variety of entities, such as a merchant/vendor or service provider, retail outlet, internet retail business, health care organization, pharmacy or health/medication provider or product supplier, health care clinic/hospital or treatment provider, communication/network access provider, technology or product vendor, restaurant/hotel or other food/hospitality provider, fuel/service or convenience store/outlet, transportation provider, insurance company or broker, financial institution or bank, personal networking service, news/media or entertainment provider, search engine/services provider, data management vendor/service, credit card issuer/merchant or consumer credit/loan provider, financial intermediary, educational institution or school, utility company, personal/home or pet care provider, business service provider, professional services firm/business, etc. in any category that now exists or that may exist in the future. For purposes of the system and method, any entity may be an “enterprise” if that entity has or intends to have interactions or transactions with one or more persons who use a mobile device (whether in a commercial or professional/personal or other context).

For enterprises such as merchants and vendors and other entities that provide informational and/or commercial services and products to consumers and potential customers (i.e. persons using mobile devices), the ability to establish and maintain communications with mobile devices is of potentially substantial commercial benefit. However, ongoing change and growth, the wide variety of mobile devices, the continuing convergence and emergence of new mobile devices, variations in operating systems/platforms for mobile devices, and interoperability issues, present challenges to enterprises who wish to communicate widely to consumers and customers through their mobile device.

Consumers may possess multiple mobile devices of different types, or may change/upgrade their mobile device multiple times within a matter of months. The set of mobile devices in operation (in the hands of consumers and potential customers) is expanding and changing, as devices come into service and other devices are taken out of service or have their service pattern changed. Customers may maintain an existing telephone number when they bring a new mobile device into service (e.g. taking the old mobile device out of service), or may obtain a new telephone number when they obtain a new mobile device (e.g. may use the new telephone number for the new mobile device or may transfer the new telephone number to the old mobile device and use the existing telephone number with the new mobile device). A single consumer may use and/or carry multiple mobile devices, for example, a mobile device used on behalf of an employer for work-related/professional functions and a mobile device used for personal and social/family communications. A consumer may have a mobile device that they use for international travel and a mobile device they use domestically when at or near home. A consumer may have a mobile device that they share with other members of a family or household, e.g. children and other relatives. A consumer may have mobile devices that are on different networks, e.g. for which connectivity of each device is provided by different service providers (or carriers).

Mobile devices come in a wide variety of types and form factors. Certain mobile devices have relatively small visible viewing areas (e.g. screens or displays, such as LCDs); other mobile devices have relatively large visible viewing areas; some mobile devices have multiple viewing screens. Certain mobile devices provide no keyboard for information entry; other mobile devices have physical keyboards and/or provide on-screen (e.g. touch screen) capability or keyboard simulation.

Mobile devices come with various data/voice communications capabilities and compatibilities; for example, certain mobile devices may use CDMA (Code Division Multiple Access) technology for communications with a service provider; other mobile devices may use, for example, GSM, 3G, 4G, or LTE technologies. Some mobile devices may also include, for example, capability for Wi-Fi or Wi-Max or other technology for communications. And carriers and other service providers continue to upgrade and enhance their networks to improve data/voice communications capability, with mobile devices concurrently being upgraded and enhanced for interoperability.

According to any exemplary embodiment, messaging communications with the mobile device will be facilitated using conventional or other known technology that is used by mobile devices and by carriers/service providers (including as indicated in FIG. 2).

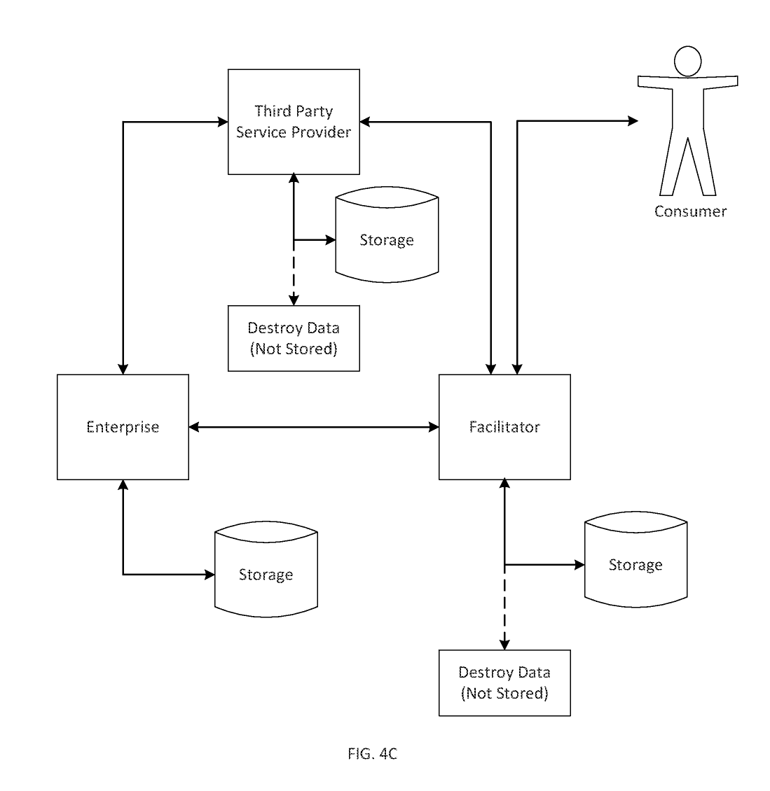

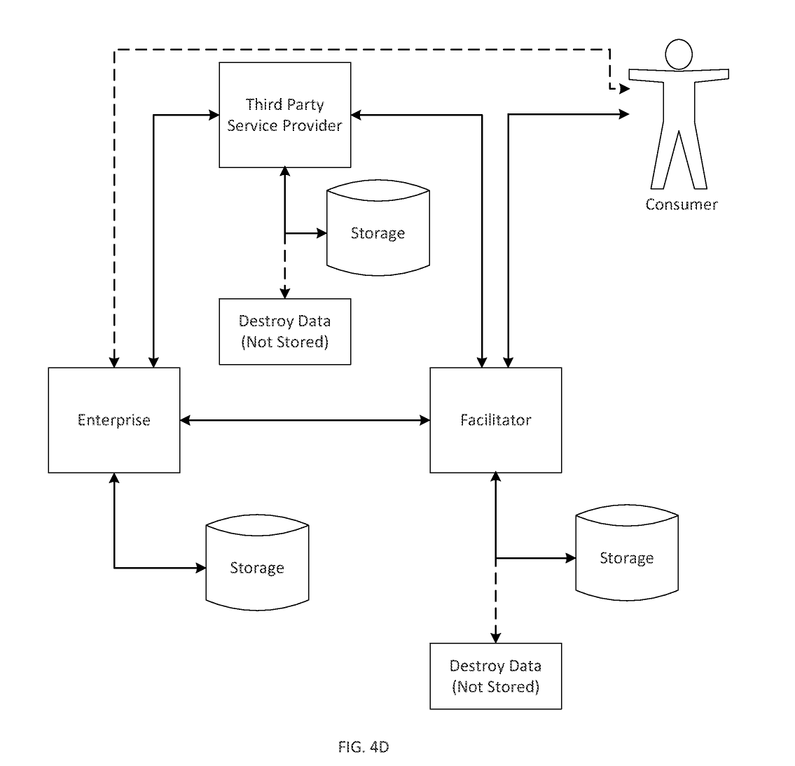

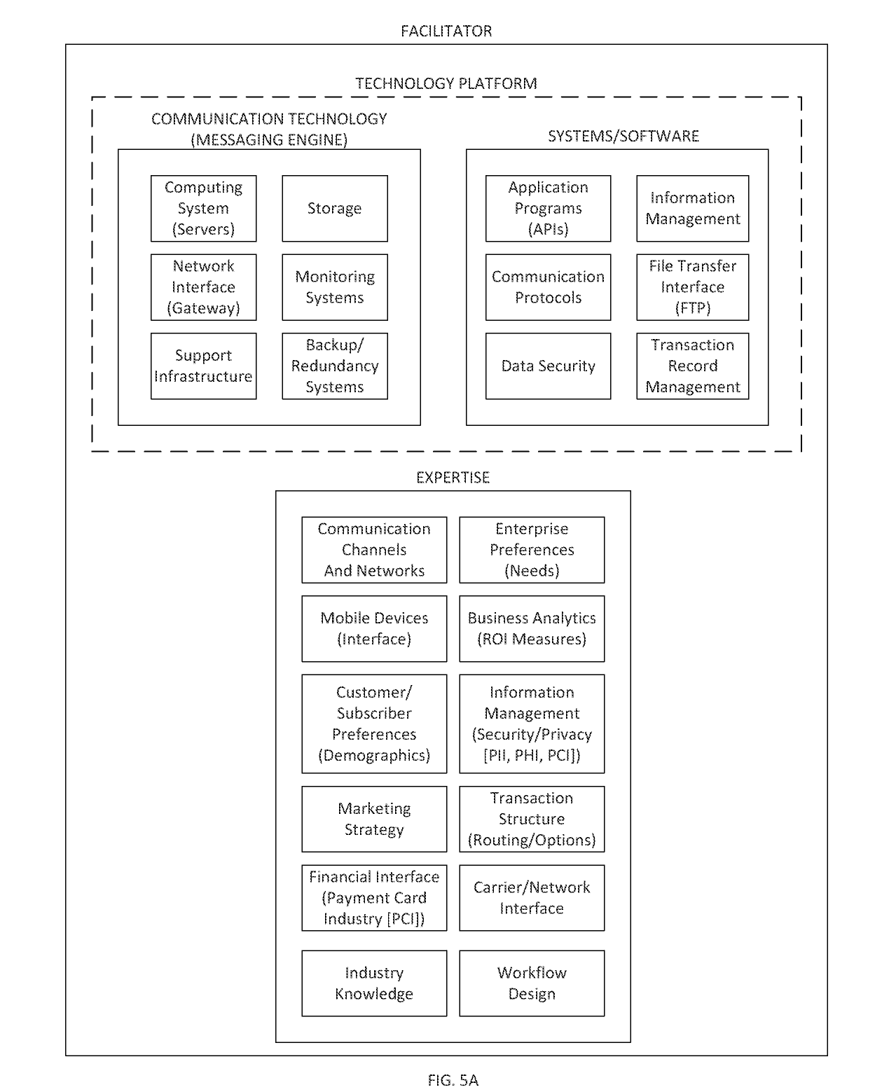

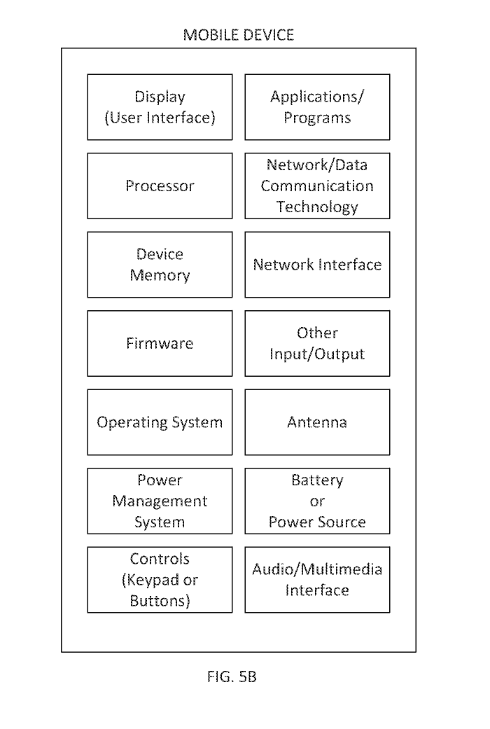

As indicated (schematically) in FIG. 5B, Mobile devices come with variations in computing power, memory, data storage capability and operating systems. For example, one mobile device may have relatively limited computing power (e.g. a relatively low speed and low capability microprocessor) and relatively little internal memory (and no additional/external memory); another mobile device may have processing/computing power similar to a laptop or netbook computer (e.g. a relatively high-speed and high power processor) and the ability to use external memory (e.g. through a SD/SDHC or micro SD card with a capacity of 4 GB, 8 GB, 16 GB, or more). Network/internet access may be via cellular telephony or carrier/network or via another wireless network or a wired/local connection to the internet/network. A mobile device of the future may have computing power that meets or exceeds the computing power of a conventional desktop or laptop computer of only a few years previously.

Mobile devices may come with a variety of different service capabilities and/or billing plans with the service provider. For example, a consumer may have a billing plan with a carrier that allows for a limited number of minutes of voice (talk) time and a limited number of messages (e.g. SMS and/or MMS messaging) and a limited amount of data use (e.g. over the internet of mobile web/mWeb). Consumer with multiple mobile devices may have different service/billing plans for each of their mobile devices. How consumers use their mobile devices may be influenced if not constrained by the billing/service plans they have with their carriers. For example, a consumer with unlimited talk/voice time but limited or restricted messaging and data communication usage may tend to interact via voice calling or using an interactive voice response system (IVR/VRS using telephony); consumers with unlimited messaging usage in their billing/plan will likely have a different usage pattern for their mobile devices.

It has become common to see persons using mobile devices in almost all corners and contexts of developed society. How and where mobile devices may properly/safely or legally be used is in flux, notwithstanding expansion of the number of mobile devices in use and expansion of the capabilities of the new mobile devices being brought into use. For example, several states now have explicit legal restrictions prohibiting the use of messaging services on mobile devices while operating a motor vehicle (e.g. laws against “driving while texting”) as well as general prohibitions against inattentive driving. Motor vehicles may have installed technology that allows “hands free” communications by a driver or passengers through a mobile device. Mobile devices may include “voice activated” or “voice recognition” technology; mobile devices may include the capability to “read” aloud messages (e.g. e-mail or SMS messaging). Certain facilities prohibit the use or carrying of mobile devices (or mobile devices with certain capabilities). In certain situations or during certain events, for example, legal proceedings, religious services or entertainment events, consumers will be asked not to use or to turn off their mobile devices or perhaps use only in “silent mode. Yet at or in connection with other situations or events, such as sporting events, consumers may be freely allowed if not invited or urged to use their mobile devices.

In connection with the marketing of products and services, to build brand/name recognition, to expand or build awareness and relationships with consumers and potential customers, and/or to maintain contact and loyalty/relationships with consumers who are existing customers, many enterprises seek to connect with consumers/customers on their mobile devices. For example, consumers may wish to receive communications such as alerts, invitations, reminders, offers, campaigns, etc. from certain enterprises. The number of enterprises that will seek to make connection with consumers/customers on their mobile devices and the scope of the connections is very likely to expand dramatically in the future.

However, given the degree of variability and flux in the field of mobile devices and their use, including changes in mobile device technology/capability and consumer usage/usage patterns, it can be difficult for enterprises to maintain connections or effective connections with consumers/customers. For example, a message or web page transmitted to a mobile device from an enterprise that appears or loads sufficiently quickly and is readily readable on one mobile device may not load properly or loads slowly on another mobile device (or may not be readily readable on the device). A consumer who has grown accustomed to interacting with an enterprise on a mobile device in a certain manner (i.e. in terms of speed or ease of readability) may find that interaction with the enterprise is no longer the same or suitable when the consumer obtains a different mobile device. Consumers who are unable to interact conveniently (for their tastes) with an enterprise through their mobile devices may instead elect to interact or transact with another enterprise. For enterprises engaged in the marketing and selling of products and services, the inability to interact efficiently with consumers on mobile devices may mean lost revenue or slowed growth.

Providing continuity and at least some relatively stable level of uniformity in the presentation of communications to consumers using mobile devices can present a challenge to an enterprise. For example, as persons obtain new devices or gain new functionality on their devices or experience changes in their situations and interests (e.g. new employment, change in marital/relationship status, relocation, new hobby, birth/adoption of a child, etc.), it may be mutually beneficial for the enterprise to be able to provide communications of ongoing relevance to the persons. Moreover, the receptivity of persons to communications from various enterprises may change over time (including for reasons not readily known to an enterprise).

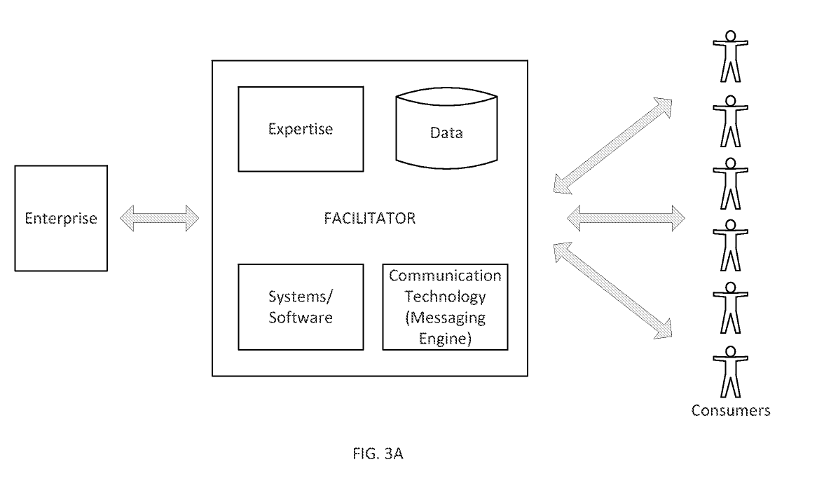

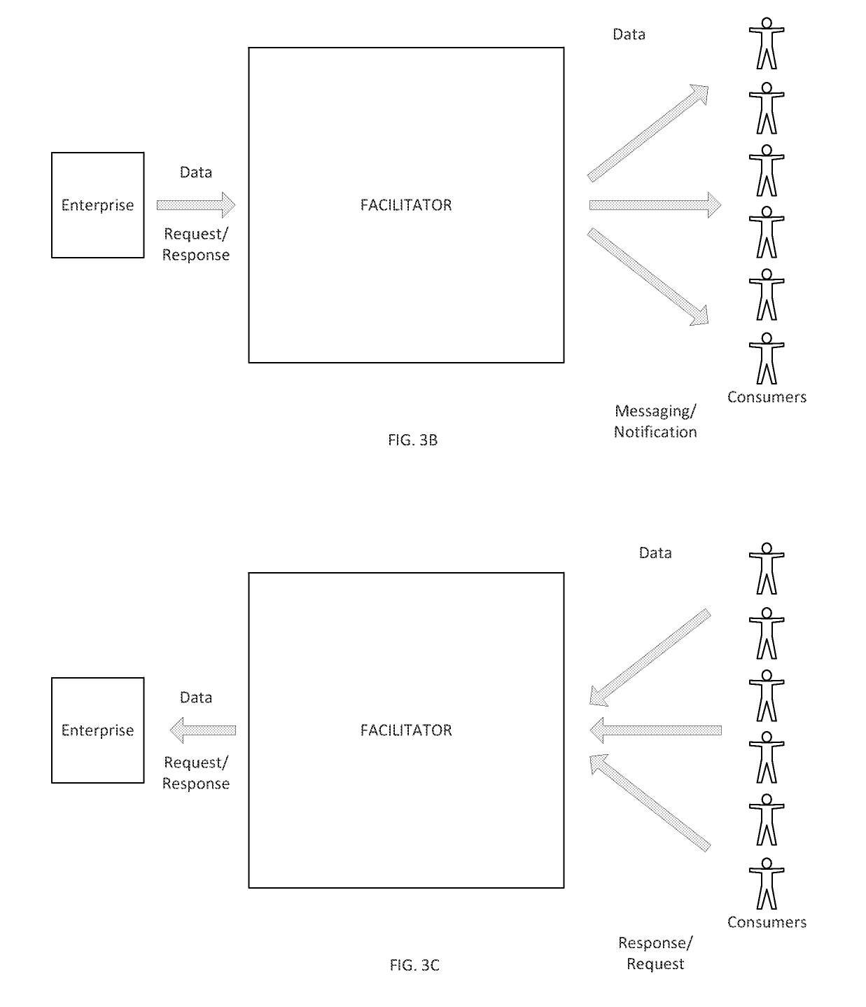

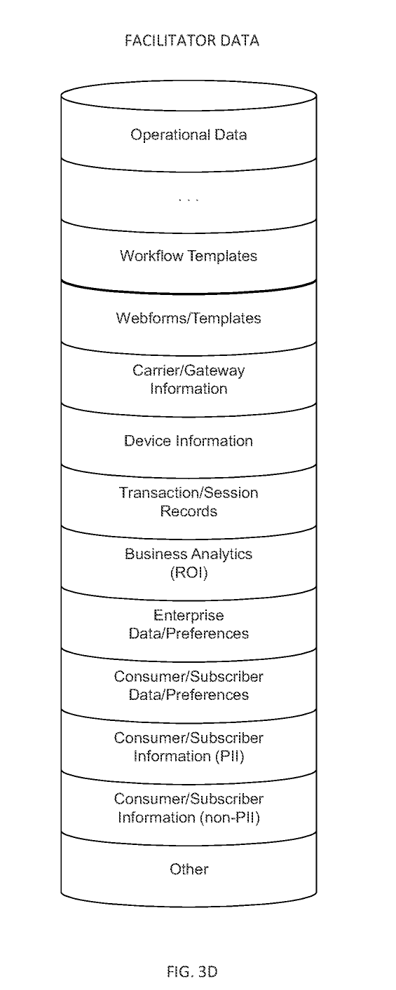

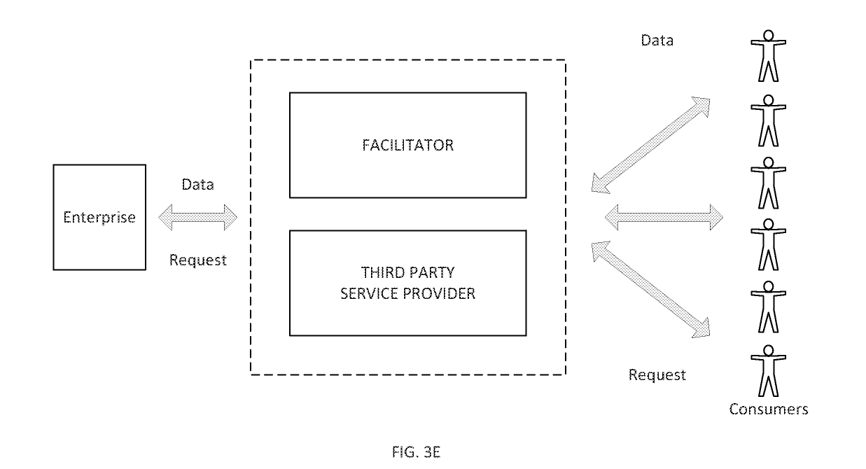

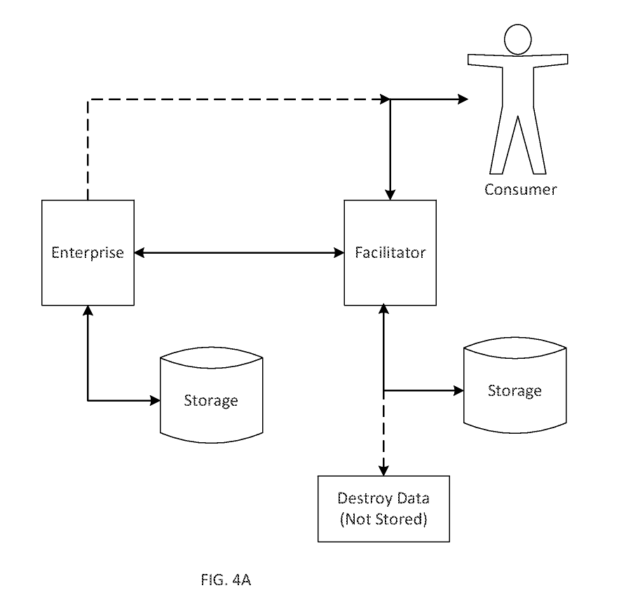

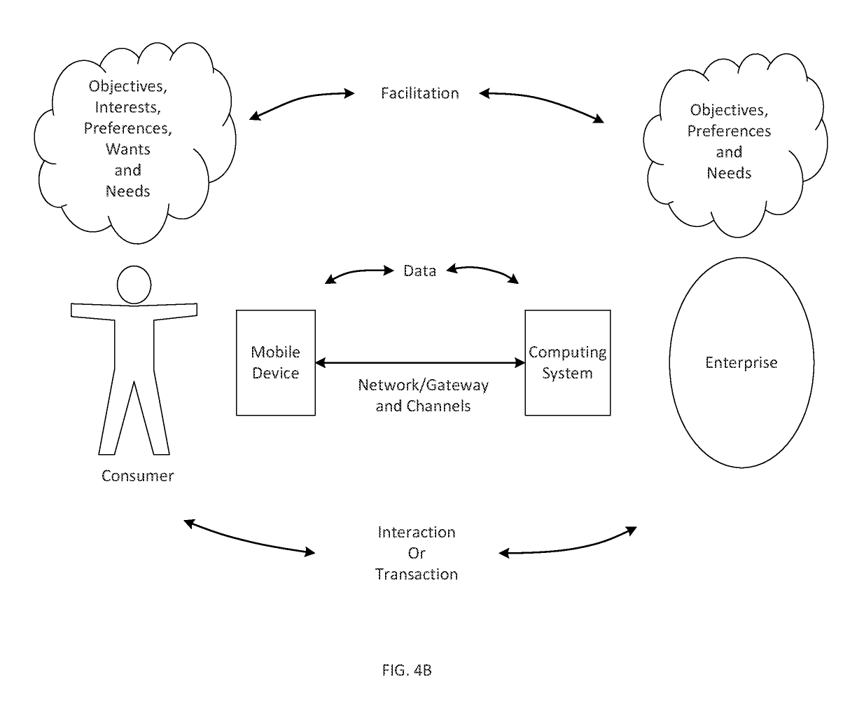

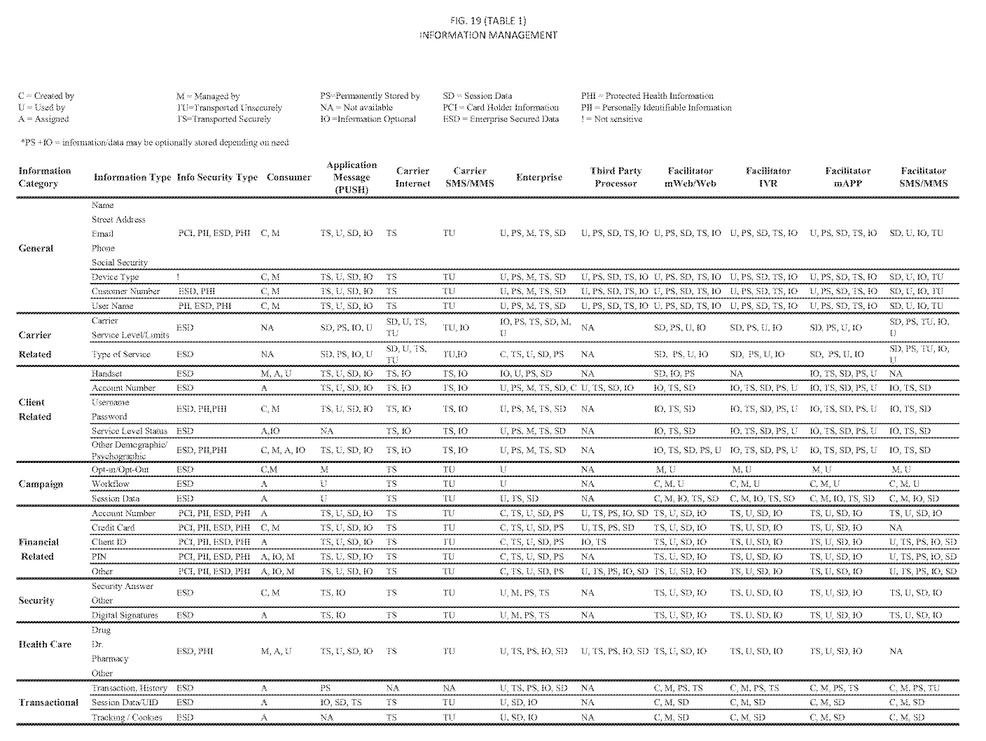

Referring to FIGS. 3A and 4A, a relatively new type of enterprise may operate as a facilitator of interactions and transactions with consumers through their mobile devices and clients (e.g. enterprises of any type/business model who wish to interact or transact/conduct business with consumers, including the sales of services and products or information/content) over one or more communication channels and networks. The facilitator is able to provide a system and method for facilitating interactions and transactions with persons using mobile devices with a technology platform as shown in FIGS. 1A through 5D, comprising among other things, systems and software operating on a computing system, network connectivity and interface, and data storage (including data management, see FIG. 19 (TABLE 1)). The technology used in the system and method of the facilitator may also comprise computing systems and network/telecommunications systems provided and operated by a carrier or communication service provider (and/or by and through a third-party service provider).

According to any exemplary embodiment of the system and method, communications with the mobile device will be facilitated by a computing system (e.g. server) generating content (e.g. a static web page, dynamic web page, etc.) that passes through a gateway to the network/communication channel for transmission and receipt by the mobile device where the relevant portions of the content are presented and displayed on a user interface (e.g. through a web browser, etc.). According to any other embodiment, other present/future technology that is used for communication of data (e.g. content such as information) between a facilitator and mobile device may be used in the system and method (i.e. the system and method uses such technology but can be implemented without requiring a specific type of such technology).

As shown in FIGS. 3B, 3C and 4B, as an intermediary, the facilitator is able to facilitate a data- or information-based communication between a consumer (i.e. actual/potential customer using a mobile device) and a merchant or other enterprise. The facilitator may provide certain capabilities that its client (e.g. the enterprise or merchant) will then not need to establish or maintain in the face of virtually constant changes in mobile devices and related technology. As shown in FIG. 3A through 4D, the facilitator may facilitate data- or information based communications and provide certain capabilities. As shown in FIG. 3E and FIGS. 4C and 4D, the facilitator may operate with a third-party service provider to perform the functions related to facilitation of the interaction or transaction (including communications with the consumer.) For example, a third-party service provider can facilitate communications and/or data storage (along with the facilitator); according to other exemplary embodiments, functions relating to the facilitation of a transaction or interaction may be shared, co-performed, allocated or otherwise distributed between the facilitator and the third-party service provider. As shown in FIGS. 3A and 5A-5D, according to an exemplary embodiment, the facilitator will contribute certain expertise (e.g. knowledge of and the ability to adjust content to fit mobile devices of various types and form factors, knowledge of mobile device users and their preferences, knowledge of industry/technology trends and developments, knowledge of billing/electronic commerce, knowledge of information security, etc.); the facilitator will also contribute technical capability such as systems/programs that operate to manage interactions (e.g. API or application program interfaces and file transfer interface/protocols) as part of a technology platform. As shown in FIGS. 3A and 5A, according to an exemplary embodiment, the facilitator will provide a computing system/gateway configured to serve as a “messaging engine” (e.g. operating through a computing system comprising a telecommunication/network interface with carriers/service providers with an established capability to transmit and receive messages, such as SMS messages or MMS messages or other messaging) to establish a connection with persons using mobile devices (e.g. consumers such as actual/potential customers). As shown in FIGS. 3A and 3D, the facilitator will also manage and maintain information and data (e.g. data about consumers such as telephone number, contact information, mobile device and their communication preferences, etc.). As shown in FIG. 5C, according to an exemplary embodiment, the third-party service provider will share some or all of the capabilities of the facilitator (and may have enhanced capabilities relative to the facilitator in certain functions); the facilitator and third-party service provider (e.g. co-facilitator) may allocate the performance of the facilitation function according to their relative capabilities, relative capacity or other considerations (e.g. including data/information management according to the intent or preferences of the enterprise/client, credit card merchant, customer, etc.).

The technology/platform provided by the facilitator to an enterprise/client to enhance the experience of a consumer and the efficacy of mobile communications with the enterprise may include features such as combined (or blended) communication methods (e.g. the ability to use multiple, integrated mobile technologies such as messaging, voice, mWeb and device-based (smart phone/mApp) applications), scalability (e.g. a messaging engine that can accommodate initiatives of any size and handle large volumes of data, in some instances millions of messages per day), stability (e.g. a redundant infrastructure, designed to protect data and store it properly), extensibility (e.g. APIs or other routines, files, forms, links/URLs able to be integrated into third-party systems, databases and business processes), uniformity/standardization across carriers and mobile devices (e.g. compatibility with carrier requirements and disparate handset technology to facilitate mobile communications in many parts of the world, in many languages and in any industry), and reporting/analytics (e.g. data collected in real-time and reported to allow review of results and insight and adjustments to maximize the value of mobile communication efforts). The facilitator may also provide a technology platform for mobile communication (e.g. to mobile devices) across various technologies and carriers, incorporating the technology for messaging (e.g. SMS/text and MMS or other formats), voice and voice response systems, web and mobile web engines with related software/application and interfaces.

According to any exemplary embodiment of the system and method, data (e.g. content such text, images, forms, pages, links/URLs, user-input templates and fields, etc.) may be presented and displayed on a mobile device using conventional or other known technology (e.g. as presently referred to as a web page, webform, web template, etc.); such data/content may be presented in a manner referred to as a static web page or rendering of a dynamic web page or webform or by other terms/other formats that can be used. According to an exemplary embodiment, content may be transmitted in the form of files such as defined in programming languages such as HTML, XHTML, Perl, PHP, or otherwise.

A facilitator can provide, maintain and improve a platform of technology and expertise for mobile communications with consumers that a typical enterprise will not readily be able to develop. A facilitator is able to provide a wide variety of additional or improved capabilities for clients who seek solutions to the challenges presented in mobile communications. The facilitator can deploy its expertise and technology to organize, structure, manage and conduct communications and interactions/transactions of virtually any type within the capability of consumers using mobile devices, across a wide variety of carriers and in different countries and different languages. In the implementation of communications, the facilitator is also able to collect and mine data from consumers, which data can be used to optimize future communications, reducing time and waste, maximizing efficiency, and enhancing the effectiveness of the enterprise/client of the facilitator (i.e. helping to determine return on investment/ROI and cost in comparison to results obtained).

A facilitator may assist an enterprise/client in a variety of different ways to enhance the experience that consumers/customers have with the enterprise in interactions/transactions conducted over mobile devices (i.e. understanding that a transaction and interaction are essentially the same in character and form). A facilitator may format communications to mobile devices in a manner that is relatively stable and uniform over a wide variety of mobile device interfaces (e.g. display screens). A facilitator may set up communication programs (e.g. campaigns or workflows) for an enterprise/client, for example, to encourage consumers/customers to transact with the enterprise, to repeat an interaction/transaction, to renew/refill a service or product, to try a new or existing product or service, etc. A communication program or campaign may be developed and implemented by the facilitator to use and combine multiple communication channels to achieve efficiencies and enhance consumer convenience; for example, in a campaign/initiative or consumer-directed program, consumers may initially be presented with a text message (e.g. by SMS messaging or MMS messaging or push notification or other messaging) and then be given the ability to respond further over the internet (e.g. using mobile web/mWeb capability or mApp capability) through a fillable-form web page submission.

The potential role of a facilitator to assist an enterprise/client with communications to consumers/customers using mobile devices is very flexible. A facilitator and/or facilitation system will allow the design and structure (and execution/implementation) of a transaction/interaction in a flexible manner, according to the purpose or intent of the enterprise/client and other possible considerations/constraints and objectives. According to any preferred embodiment, the interaction/transaction can be designed and implemented/executed to uses the capabilities (e.g. breadth, flexibility, etc.) of the facilitator and the facilitation system (see generally FIGS. 5A-5D and FIGS. 14 through 19, for example). A facilitator may manage and monitor consumer interest and activity for an enterprise/client by periodically sending messages to consumer mobile devices (e.g. by SMS technology or MMS technology or push notification or other messaging technology) and inviting inquiries and responses indicating interest levels. In a marketing effort or campaign, consumers/customers may be invited to sign up or opt-in to receive periodic (and real-time) alerts and offers relating to products, services or information/events of interest to them, which allows the enterprise/client to maintain an ongoing relationship with the consumer. Future subject-based communications such as marketing campaigns on behalf of the enterprise to consumers by mobile device may be tailored or targeted to those consumers who have indicated an interest in the subject.

A facilitator may assist an enterprise/client with the management and implementation of internal communications with employees who use mobile devices, for example, by broadcast messaging (e.g. by SMS technology or MMS technology or push notification or other messaging technology).

A facilitator may assist an enterprise/client in the expansion of communication-based capabilities for customers/visitors; for example, in the entertainment/hospitality industry, a facilitator may provide for the enterprise enhanced guest experiences at a destination by managing and implementing messaging (e.g. by SMS technology or MMS technology or push notification or other messaging technology) to present information to guests about status and events at the destination; guests may be able to make arrangements for events using messaging (e.g. by SMS technology or MMS technology or push notification or other messaging technology).

The facilitator may assist an enterprise with providing notifications to consumers/customers using messaging (e.g. SMS, MMS or push technology); for example, a pharmacy or other enterprise can use messaging to notify customers when products (e.g. prescriptions or photograph prints) are available to the customer for pick-up. The facilitator may assist an enterprise/client by providing reminders to customers of appointments and confirmation and rescheduling services using messaging over a mobile device (e.g. by SMS technology or MMS technology or push notification or other messaging technology); customers who wish to or are requested to provide additional information may be enabled to do so on their mobile device in response by completing a fillable-form transmitted to them over the mobile web (e.g. mWeb) and/or the internet.

Building and applying data and information shared by the consumer (or obtained with appropriate permissions granted or otherwise as authorized), the facilitator is able to customize and personalize interactions and transactions between the consumer on a mobile device and the enterprise/client. Such interactions can be tailored and adjusted at the request of the consumer, who may elect to opt-out of receiving communications, or who may seek to have episodic and/or regular scheduled messaging or reminders (e.g. by SMS, MMS, push message) (on a daily, weekly, monthly, or other timed/scheduled basis) on subjects of interest. Enterprises may also be able to present marketing messages and advertisements through the facilitator in the communications with consumers as a source of direct revenue or indirect revenue growth; shared content or links to sites of related business partners may also be presented to consumers, as a source of potential revenue and business growth for the enterprise.

As data and information is obtained by the facilitator and enterprise/clients, directly or from transactions with consumers, precautions may be exercised as to the handling of the information. As indicated in FIG. 19 (TABLE 1), management of information of a wide variety of types and categories can be addressed as part of the design/structure and implementation/execution of a transaction or other interaction, including determination of the person/entity that will create, read, update, delete, combine, correct, use, manage, transport (secured/unsecured), authenticate/authorize, store (permanent or transient), structure, etc. the data/information. Personally-identifiable information (PII) is one category of information that is given legal protection in certain instances; other categories of sensitive or protected/personal information (which may be considered as a subset of PII or otherwise) may include Protected/Personal Healthcare Information (PHI), Protected/Personal Credit Information (PCI). Enterprise Secured Data (ESD) is another category of information that may be protected (as it may contain PII or other confidential/sensitive information). As shown in TABLE 1, the facilitator and enterprise may structure responsibility as to the proper handling of PII (and PHI, PCI, etc.) and other related information obtained from consumers/customers (including other types of information that may be entitled to legal protection). Referring to FIG. 19/TABLE 1, data/information types and categories may include (but will not be limited to) general, personal (including to the person and as to devices used), carrier-related (network access/service provider-related), client-related (enterprise-related), program or campaign related (e.g. for a particular transaction/interaction), financial related (e.g. bank/credit card/payment system related), health-care related, transactional/transaction-specific, or other (such as for system/software or technology compatibility or connectivity).

Referring to FIGS. 3A, 3D and 5A, the facilitator brings various capabilities to use for enterprises and consumers, such as expertise, communication/computing technology including messaging using systems and software (such as application program interfaces, data/file interfaces and related programs), and data information storage and management.

Referring to FIG. 5A, the facilitator is able to manage and maintain data and information relating to its relationships and knowledge of enterprises/clients, consumers, mobile devices and carriers.

Referring to FIG. 5D, according to an exemplary embodiment of the system and method, system functionality that is provided by the facilitator to assist in the design and execution of sessions (e.g. interactions and transactions) between the enterprise and consumers/customers is shown. According to any preferred embodiment, the system functionality will include a set of capabilities that allow entities (including entities other than the facilitator that will participate and/or facilitate) to design and “automate” business processes for the enterprise.

According to an exemplary embodiment as shown in FIG. 5D, the system functionality comprises the capability to manage a session (e.g. an interaction or transaction with a customer/consumer) according to the design of the session (e.g. to “automate” or execute the session as intended); the system functionality provided by the facilitator will allow entities (e.g. users and participants) to use multiple platforms for the transmission and communication of data/information for a session, for example, internet or web page/communications accessible over the web/network (including mWeb, web communications/pages specially configured for mobile devices), applications operating on the mobile device (such as mApp, mobile applications), and messaging (such as text messaging, SMS, MMS, electronic mail, etc.).

According to an exemplary embodiment, the system functionality will access a data storage system (e.g. data store) available for the session; according to a preferred embodiment, the data store will be “unstructured” insofar as it provides storage locations that can be configured and used flexibly according to the configuration of the particular session; in other words, availability of the data store is provided as system functionality but the actual data that is contained in the data store for a particular session will vary according to the design and needs/configuration of the session.

According to an exemplary embodiment, the system functionality will include the capability to facilitate and manage the “session” or interchange of data/information for the interaction or transaction; the system functionality will by application program interface (API) enable other entities to execute operations, for example, to create, read, update and delete data/information interchanged with the consumer, as well as access to a “notify” service (e.g. to inform the enterprise of other entity of data/information obtained during the create, read, update and delete (CRUD) operations). According to a preferred embodiment, the system functionality will allow the “unstructured” data store to be used for session data/information, e.g. creating data, reading data, updating data in the data store and then deleting all or part of the session data from the data store after the session; the session data may be given a pre-determined life span, a pre-determined number of uses or may be configured for the particular session or for a particular type of session.

According to an exemplary embodiment, the system functionality will include capability to facilitate information interchange management of users/consumers and for authentication routines and protocols as required by other participants in the transaction (e.g. by the enterprise or a third-party processor such as a bank or credit card company); according to an alternative embodiment, a separate or additional authentication or authorization function or layer may be provided by the facilitator as part of the system functionality. Authentication may comprise user/device authentication and/or consumer authentication. Authentication may comprise any type of authorization or authentication routine or protocol that is used or capable of use for a session/interaction on behalf of an enterprise or other entity. The system functionality may also comprise the capability to manage the creation, and use/passage of “tokens” between participants in the transaction (and providing PURL support).

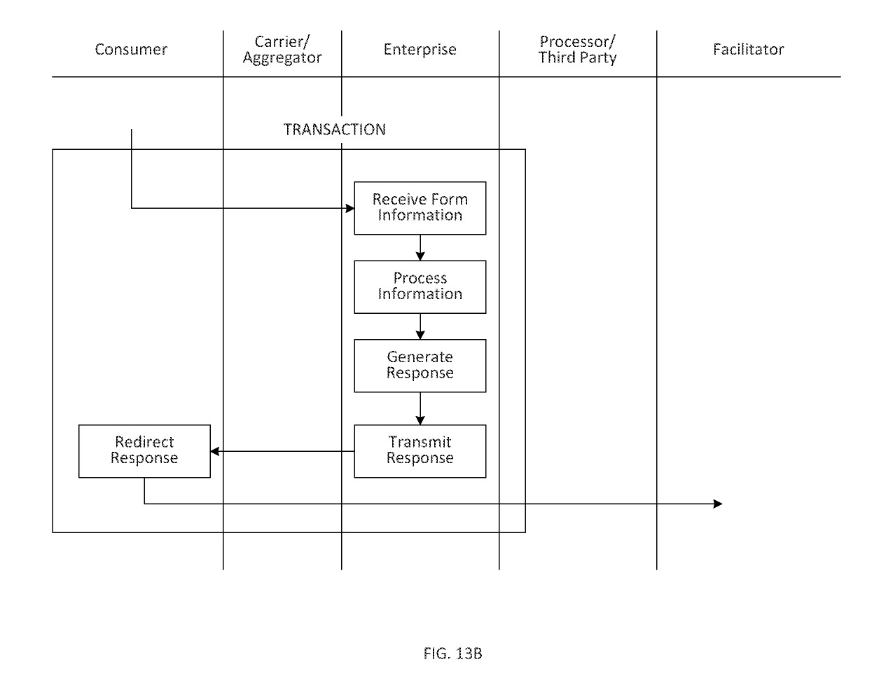

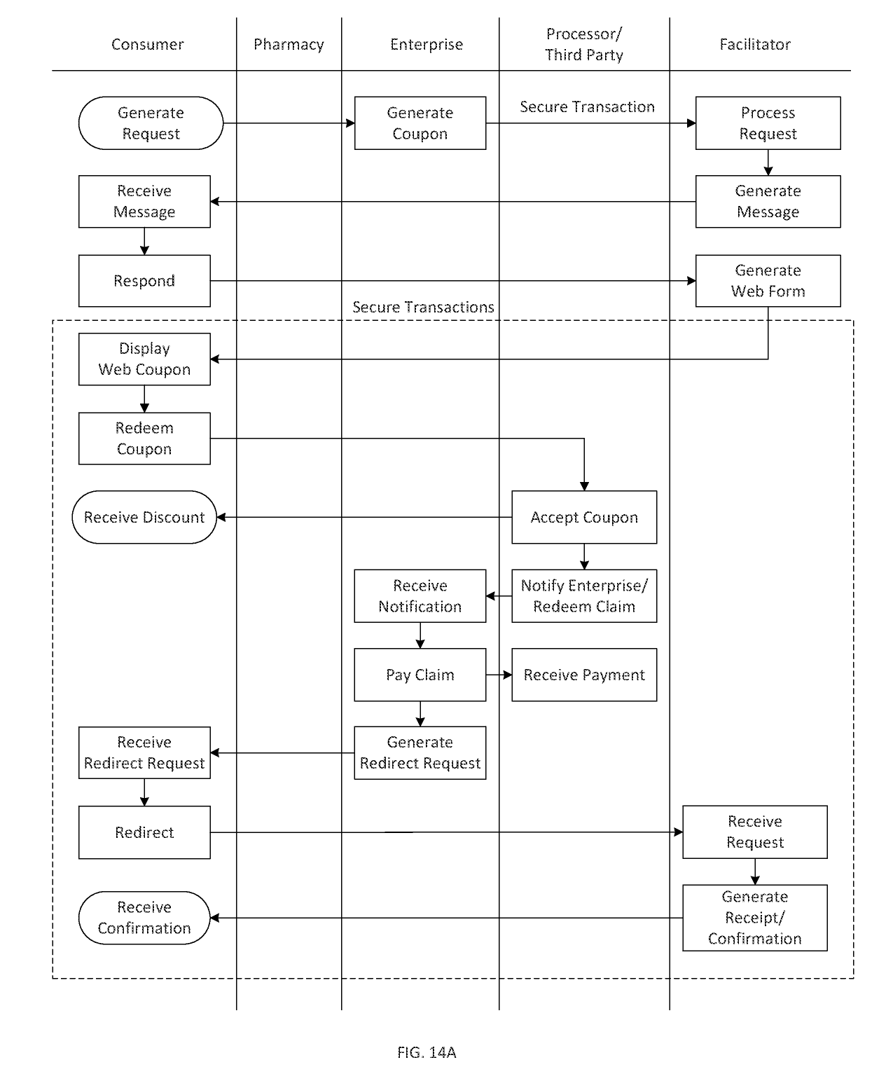

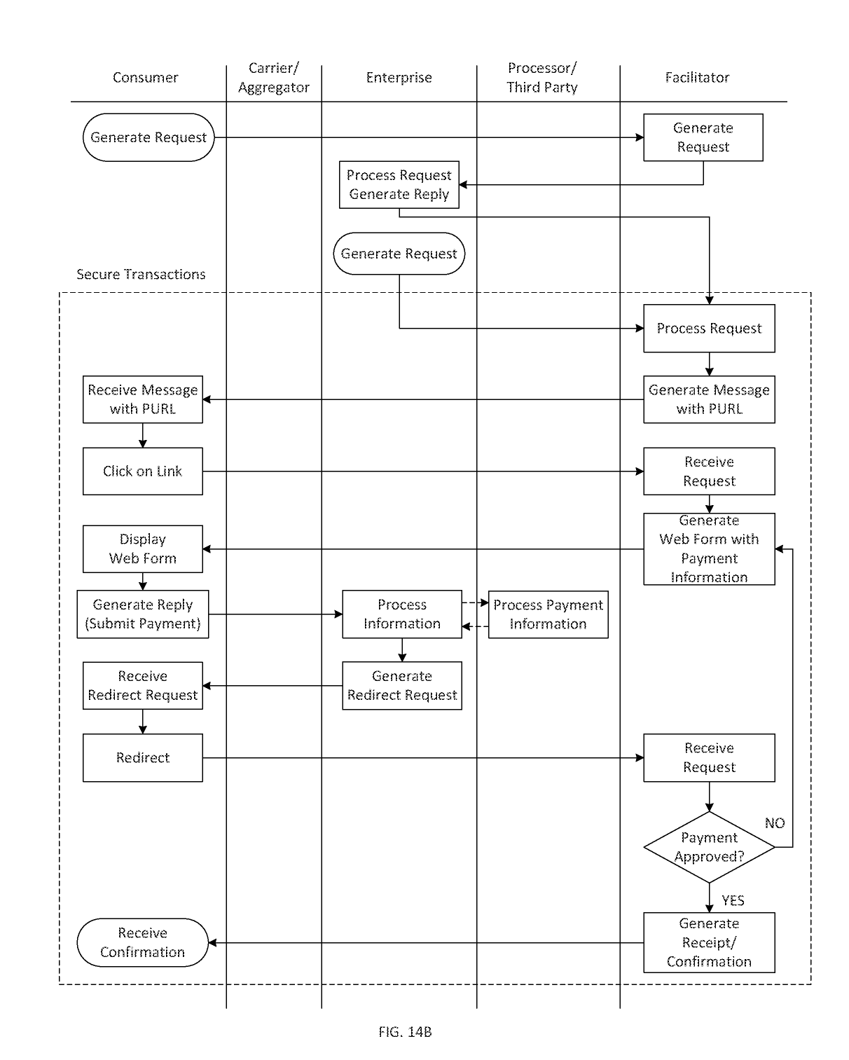

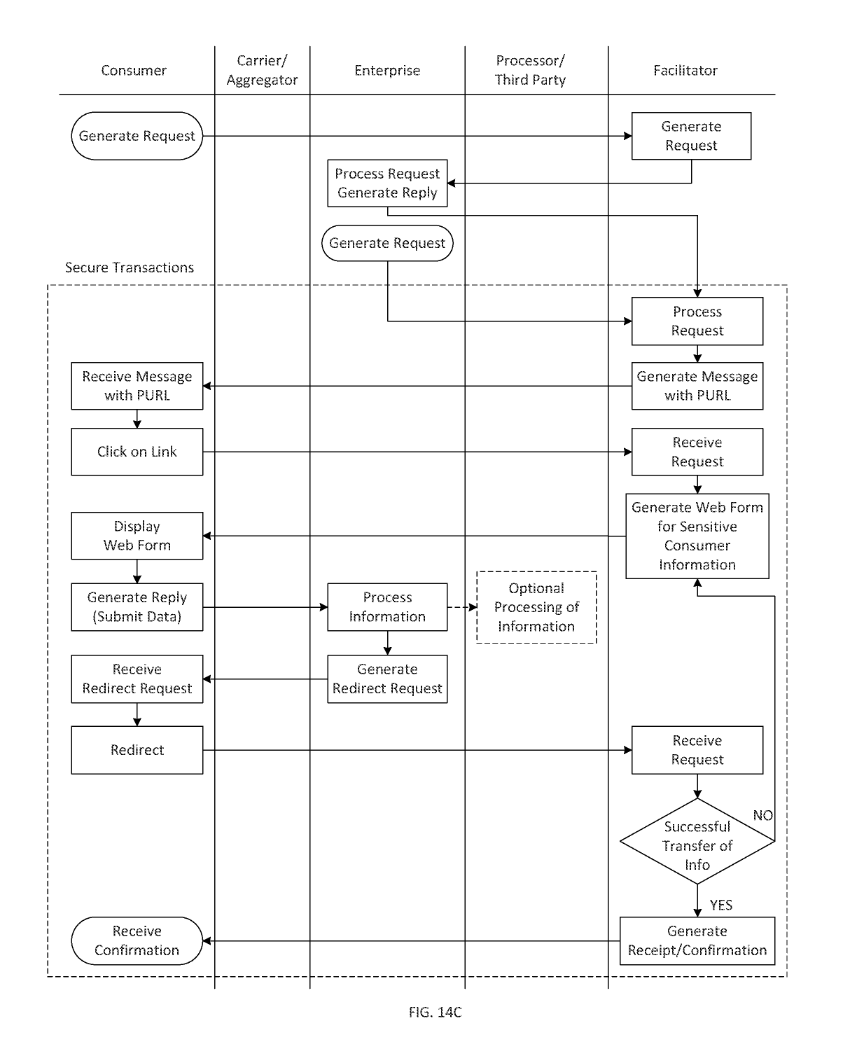

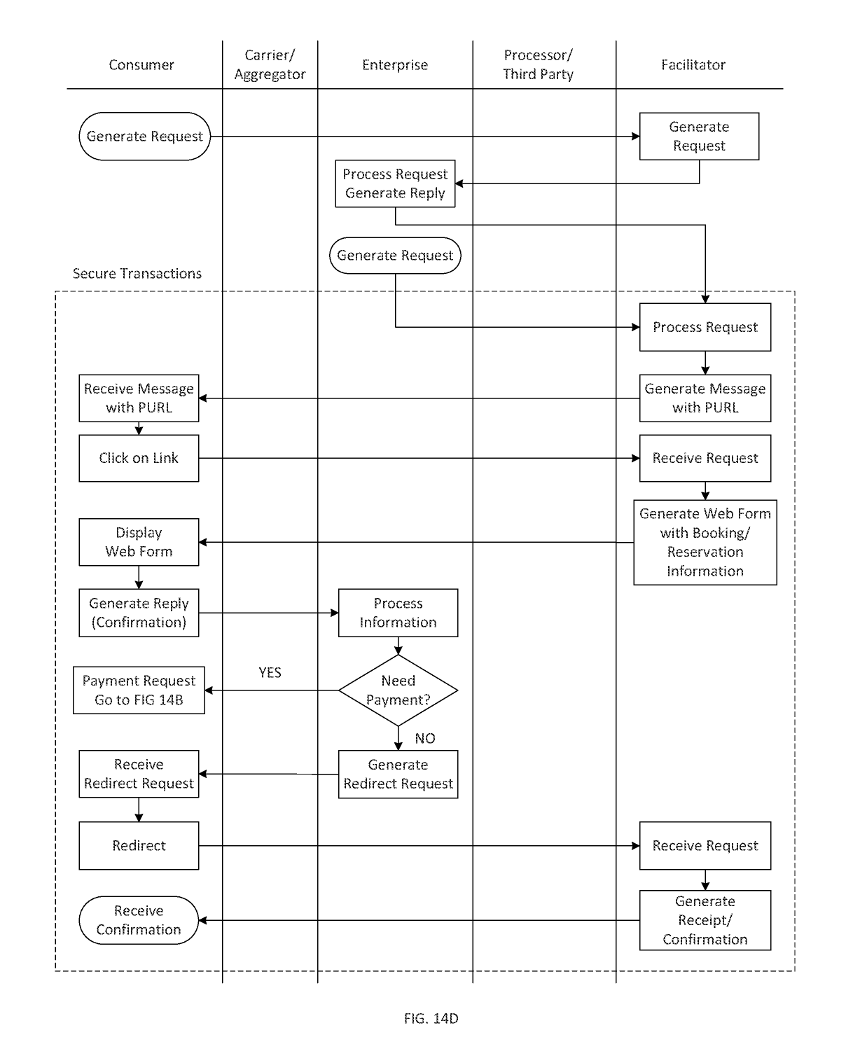

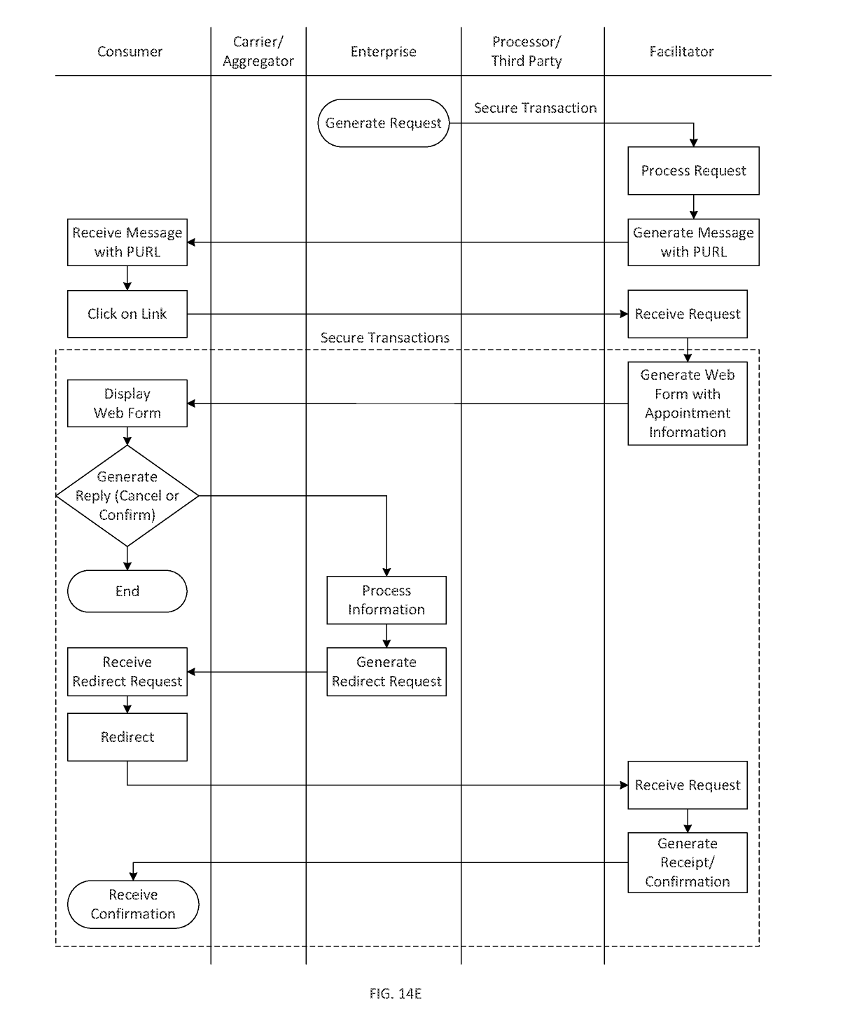

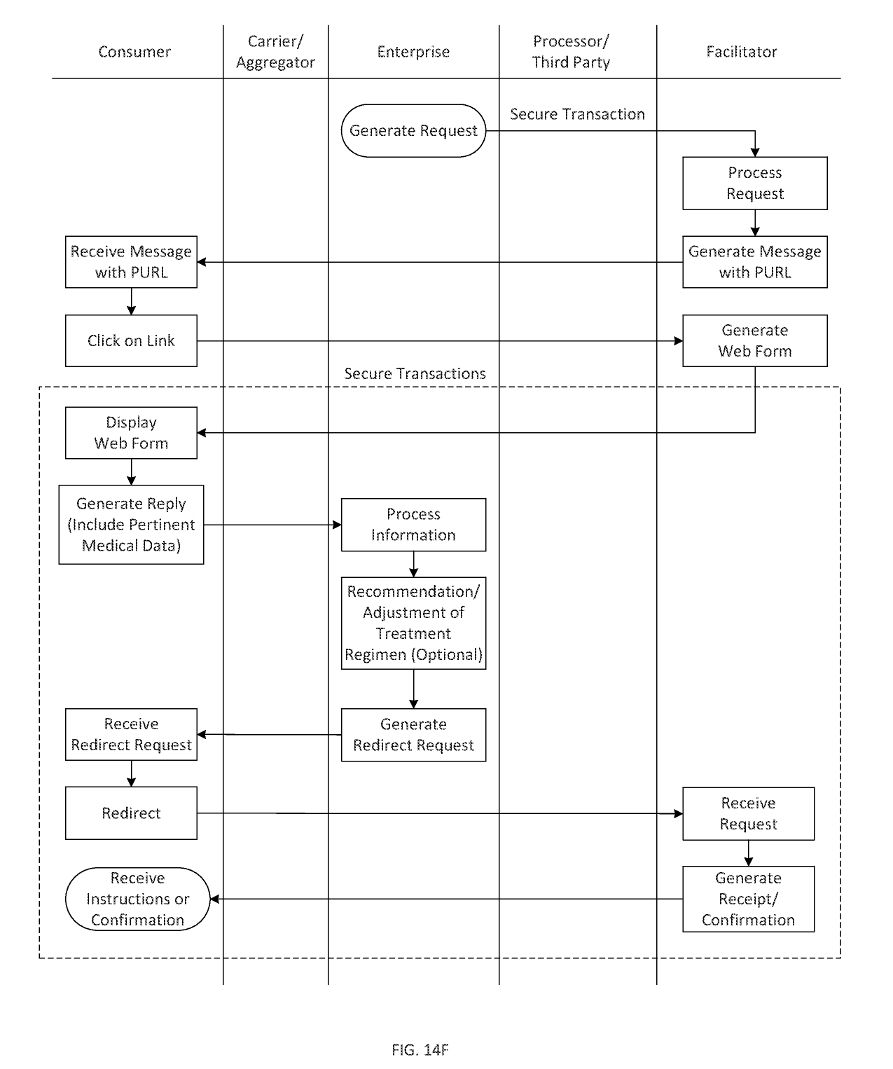

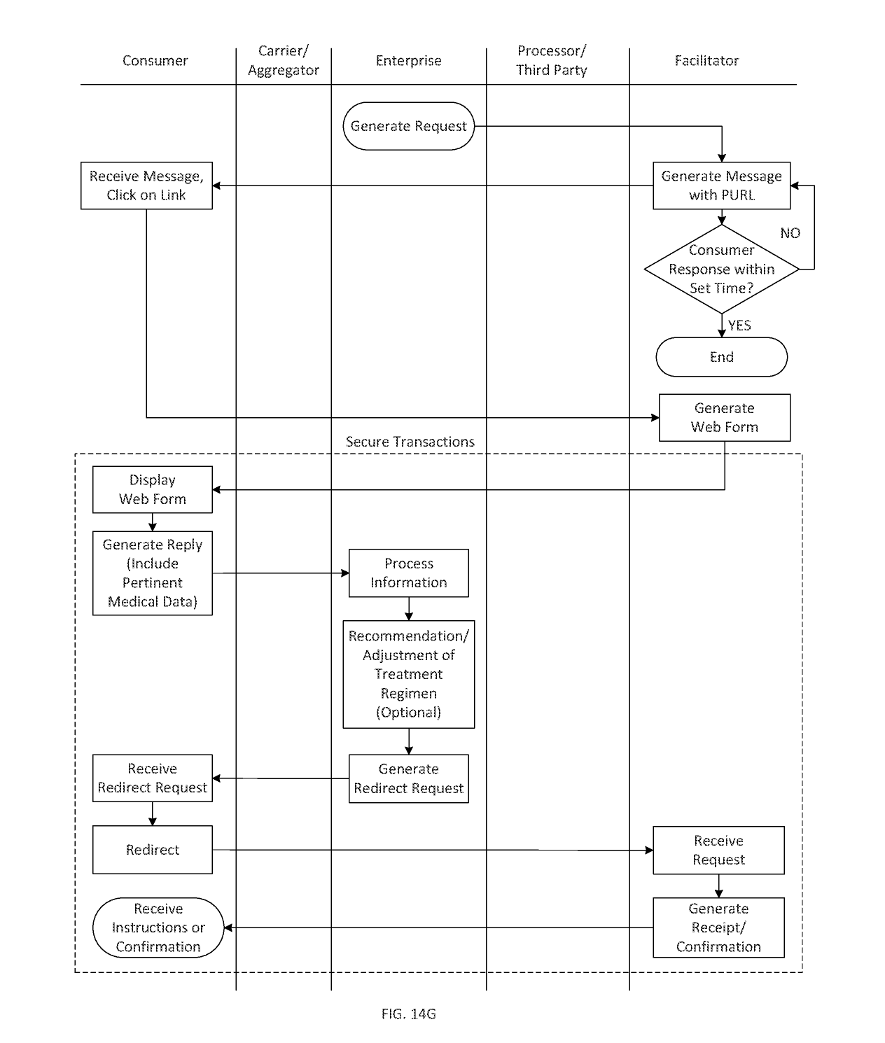

FIGS. 6A through 18B show various exemplary embodiments of systems and methods for facilitation of interactions and transactions with persons using mobile devices. According to an exemplary embodiment, the facilitator will structure the interaction or transaction on behalf of an enterprise; the facilitator may then manage the interaction and transaction for or on behalf of the enterprise. As shown in FIGS. 6A through 17 the function of facilitation may be performed by the facilitator alone or with services provided by the third-party service provider. The interaction/transaction will comprise the transmission and receipt of data (i.e. information and files) between the facilitator and the mobile device, as well as between the enterprise (and potentially other entities), over networks/communication channels (such as the internet and carrier/telecommunication networks). According to any exemplary embodiment of the system and method, data will be structured (i.e. by file format or formats) and transmitted (i.e. on the network or telecommunication channel) in whatever manner is conventional or compatible for the interaction/transaction with the mobile device; the content and form of the data (i.e. information and/or files) as presented to the mobile device by the facilitator will provide functionality and capability to allow the mobile device to conduct the interaction/transaction, for example, as indicated in FIGS. 14A through 14G.

### EXAMPLES

Example transactions and interactions are shown schematically (e.g. FIGS. 6 through 18), according to exemplary embodiments of the system and method. As shown in FIGS. 6A and 6B an enterprise may generate a request for a communication with consumers/potential customers (e.g. a marketing initiative or a campaign) that is forwarded to the facilitator. Typically, the request contains a consumer phone number or a list of consumer phone numbers that are to be included in the campaign. The request may be, for example, in the form of information in a shared data file or an application program interface (API) and may contain an actionable request (i.e. a request that is received in a manner to allow an action to be taken). The request may also contain additional information regarding the consumer, such as demographic information (e.g. age, gender, zip code, etc.). See also FIG. 19.

Upon receipt of the request the facilitator processes the information to generate a message or a group of messages that can be sent to specified consumers (see FIGS. 6A and 6B). As shown in FIG. 6A the additional information included in the request may be used in generating a unique “personal uniform resource locator” (PURL) that can be embedded in the message as a link. The PURL may be specific to each consumer receiving a message. The message may be for example in the form of a text message (SMS), multimedia message (MMS), push notification or an e-mail.

The consumer can open the message on his/her device and generate a reply that can be sent to the enterprise (see FIG. 6A). If the message contains an embedded PURL link, the consumer can “click on” the PURL link (e.g. access/activate a file or web based action over a network) to facilitate the submission of information. The message may include form fields that the consumer may fill out with information and submit to the enterprise.

According to an alternative embodiment, the facilitator may generate a message with instructions to display a form page (e.g. using an API) on the consumer device (see FIG. 6B). By opening the message the consumer may view the form and fill in the requested information. The consumer can then submit the form with the information to the enterprise.

The facilitator directs the flow of information (e.g. by using web links that open a form and direct its submission) so that sensitive information (e.g. PII, PCI, PHI, ESD, etc.) is only received by the enterprise (or further down the line from the enterprise by a processor/bank) but not by the facilitator, thus avoiding any need for the facilitator to manage or destroy such sensitive information after use.

The enterprise receives the form along with the information submitted by the consumer and processes it securely. If the transaction involves a payment, the enterprise may engage a financial institution in the process. The enterprise may then respond to the consumer with a redirect request (e.g. if using mWeb, as in FIG. 6A), instructing the consumer's device to retrieve a receipt document from the facilitator. The redirect request may include data to be included on the receipt document, such as a confirmation number, transaction identification, session identification, or status of the transaction. The consumer's device will then connect to the facilitator's web server to receive the receipt document. Alternatively the enterprise may request a receipt directly from the facilitator, as shown in FIG. 6B.

Once the workflow has been set up and customized for a particular enterprise, the process can also be initiated by a consumer, as shown in FIG. 6C. This may happen for example in the context of a hotel check-out or another similar situation. After the consumer generates and sends a request, it is processed by the facilitator and sent to the enterprise for further processing. After the enterprise has processed the data, the facilitator will generate a message and send it to the consumer. The consumer may generate a reply to the message. The enterprise will process the reply, and a receipt is displayed on the consumer device. According to an exemplary embodiment, the transaction can also be performed using APIs (e.g. application program interface to an application program operated or allowed by the facilitator) or mWeb (network connectivity through a web (page) browser or other program operating on the mobile device able to receive/transmit and display information over a network), or a combination of API and mWeb.

A facilitator is also able to structure and streamline commercial transactions that are conducted by consumers on mobile devices with an enterprise/client. A facilitator may provide expertise and technology (e.g. including APIs and other interfaces and/or data/file transfer systems and methods) that enable an enterprise to offer secure payment processing (through a bank or processor) on behalf of consumers via their mobile devices. The facilitator is able to manage electronic commerce transactions to allow for various billing methods, for example, credit card processing or billing through the consumer's telephone service provider (e.g. carrier).

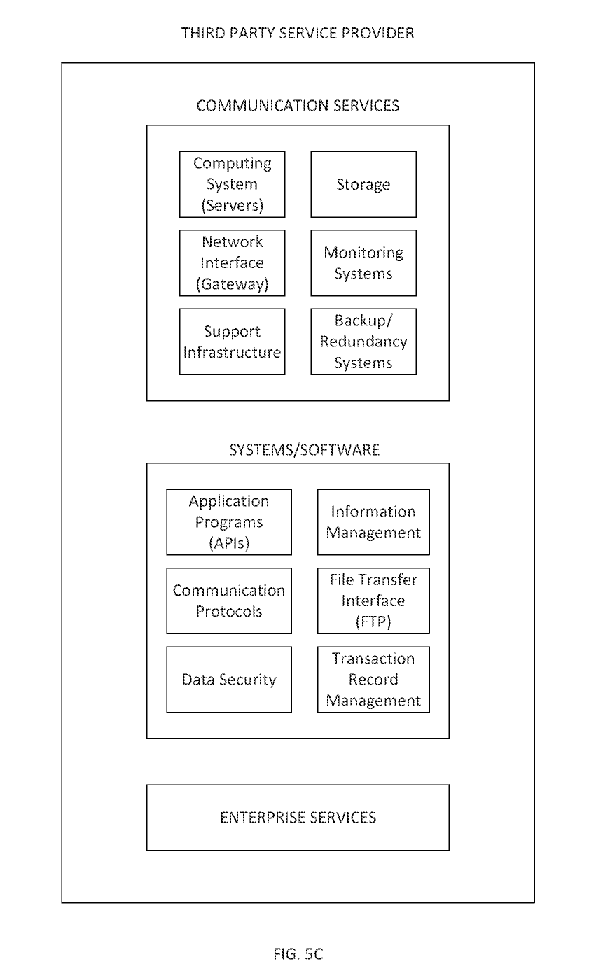

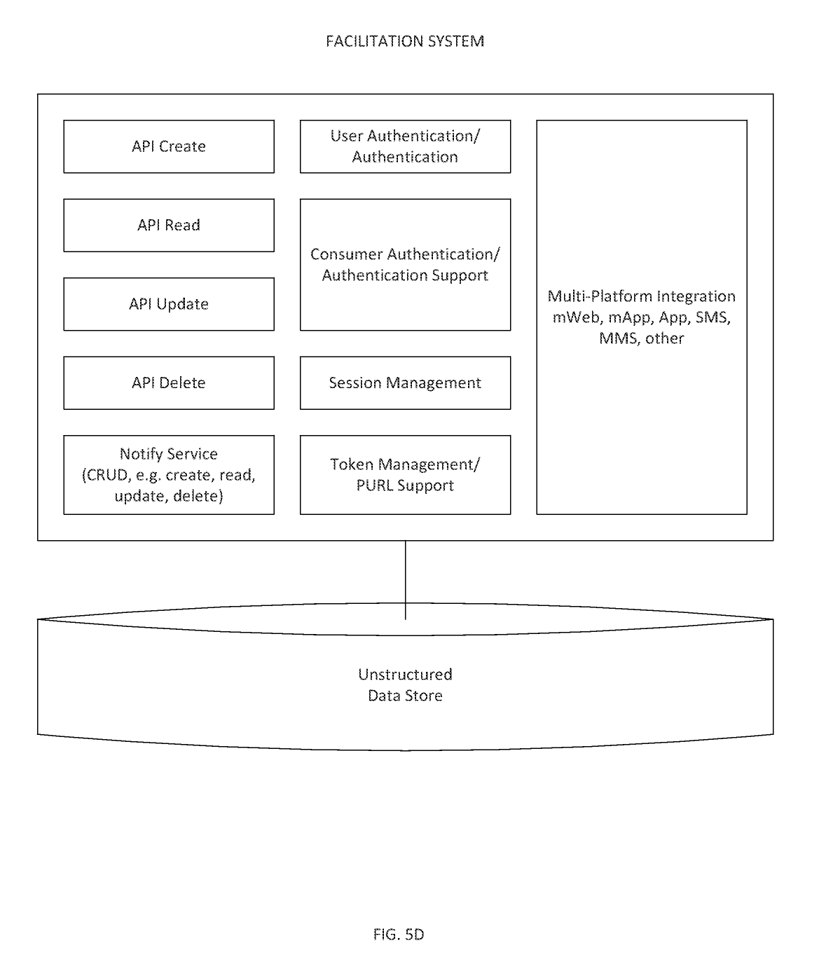

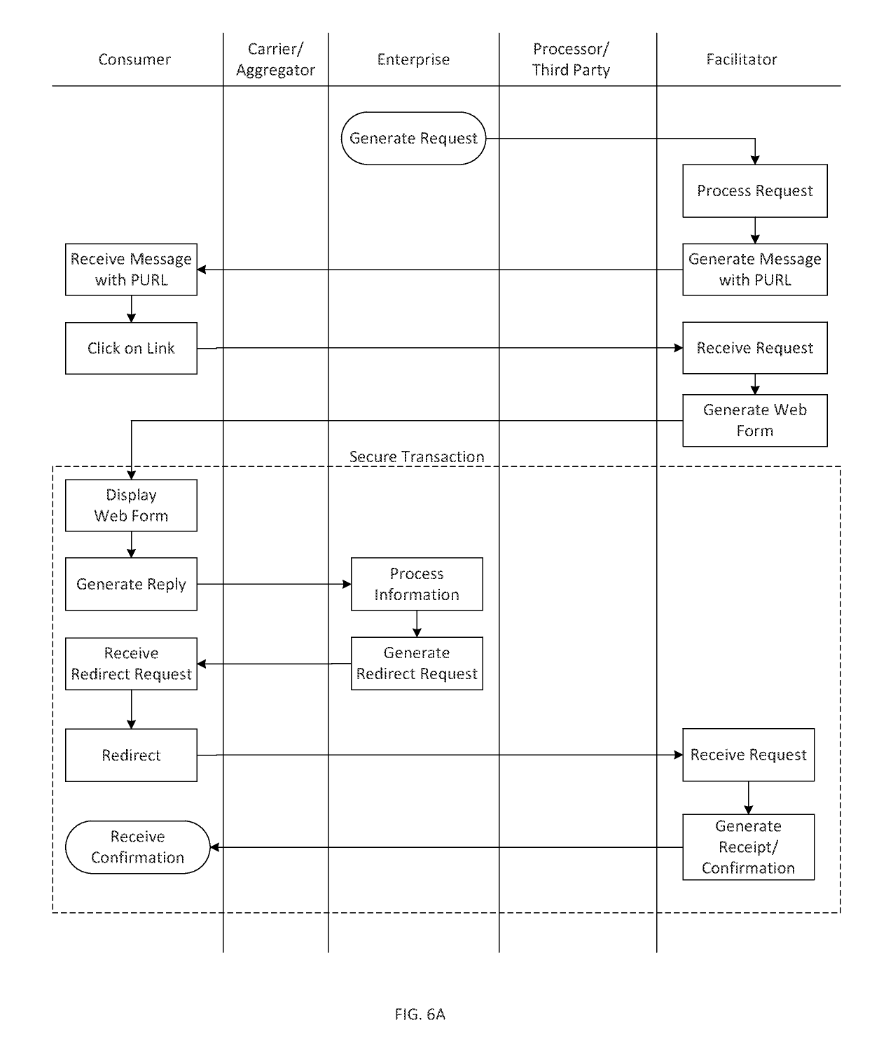

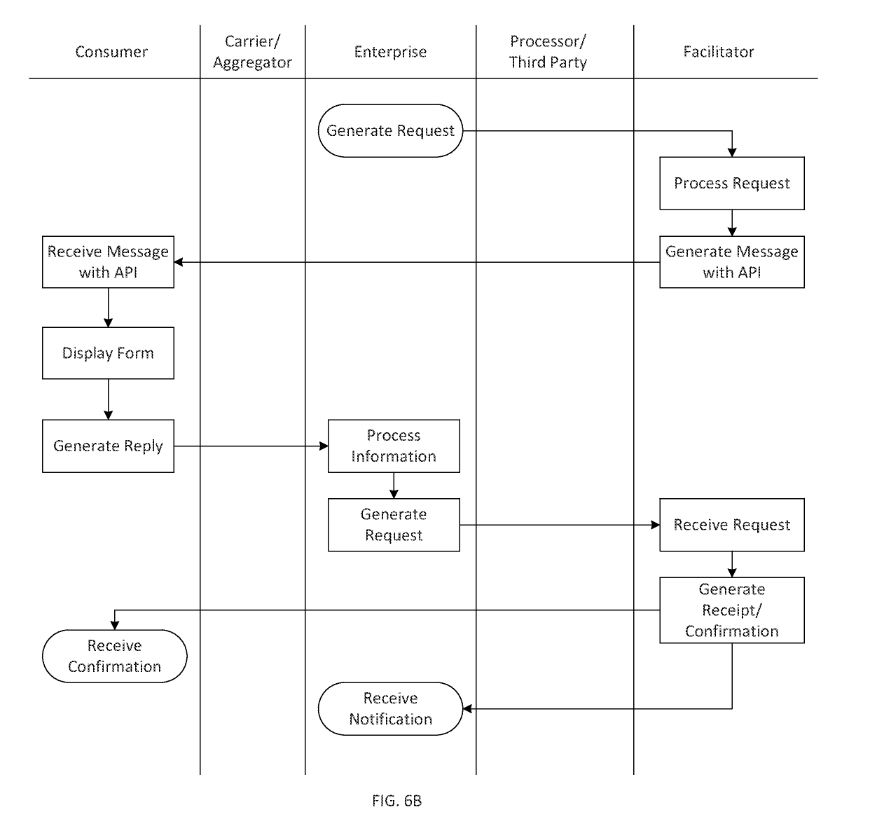

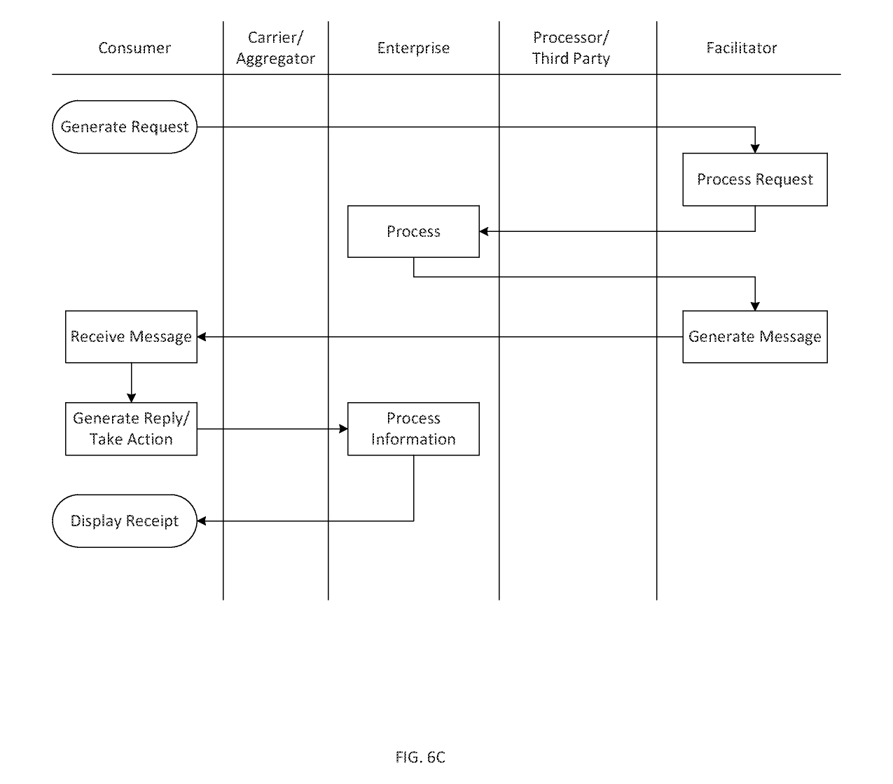

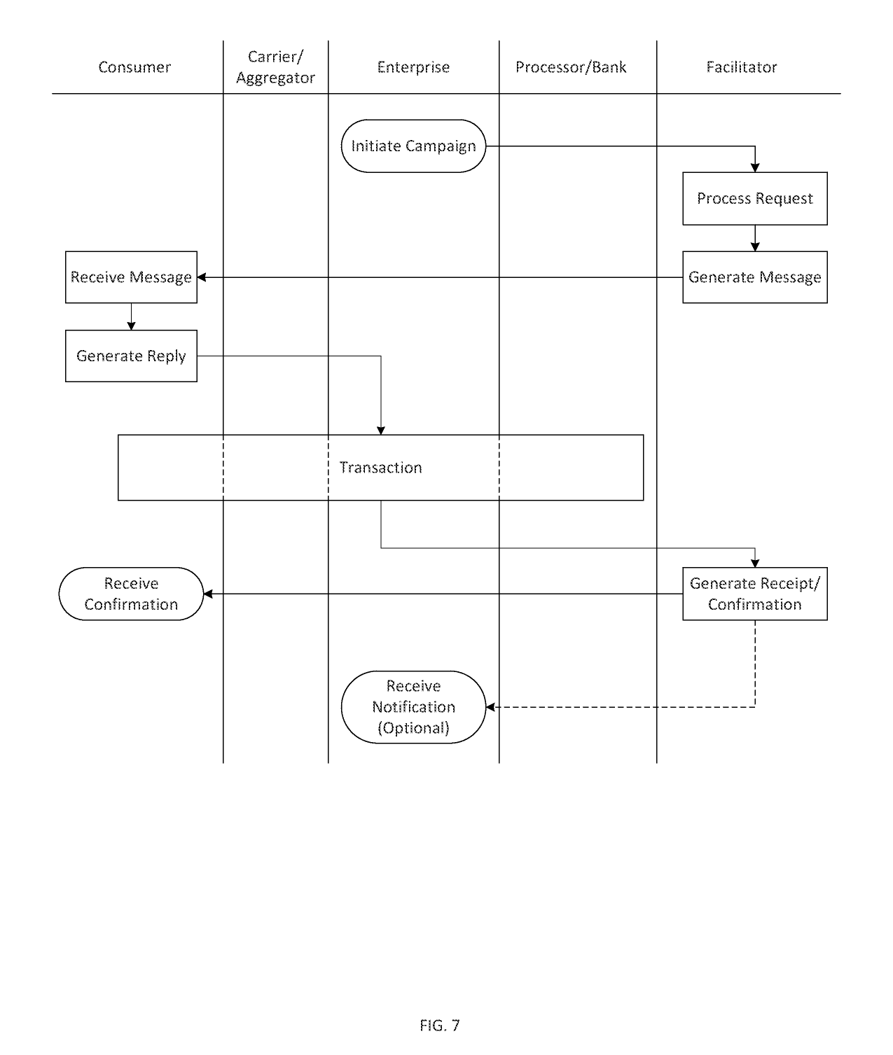

An exemplary embodiment including a transaction is shown in FIG. 7. The enterprise may initiate a campaign by generating a request that it forwards to the facilitator. Upon receipt of the request the facilitator processes the information to generate a message or a group of messages that can be sent to specified consumers. The consumer can process the message on his/her device and send a reply (e.g. a transaction request that includes information submitted by the consumer) to the enterprise, initiating a financial transaction. The transaction may involve the consumer, the enterprise and a processor/bank. The information submitted by the consumer may be processed by the enterprise and/or the processor/bank. After the transaction is complete the facilitator generates a confirmation/receipt for the consumer and optionally also notify the enterprise of the success of the process.

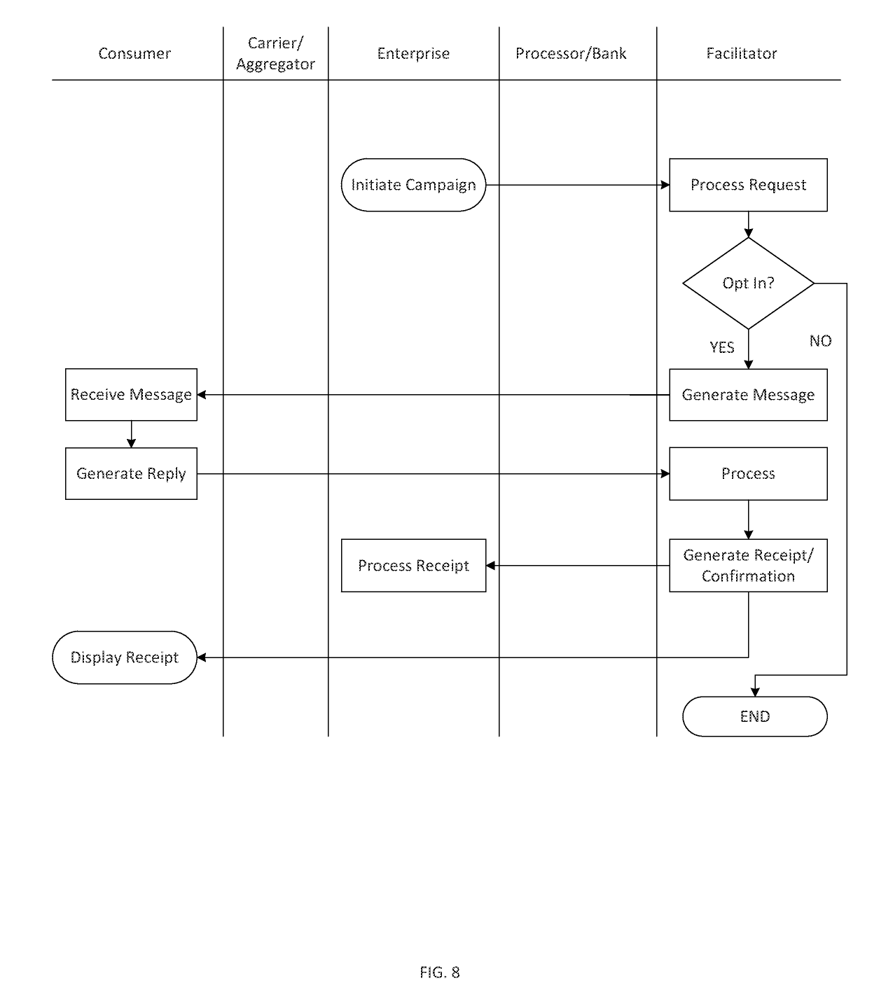

Referring to FIG. 8, among other things, the facilitator may gather data on whether a consumer has opted in or out of a campaign or service. After the enterprise initiates a campaign, the facilitator can check the list of consumers against its database and determine which consumers have opted in. If a consumer has opted in, a message is generated and sent to the consumer. If, on the other hand, a consumer has opted out, the process ends and no message is sent.

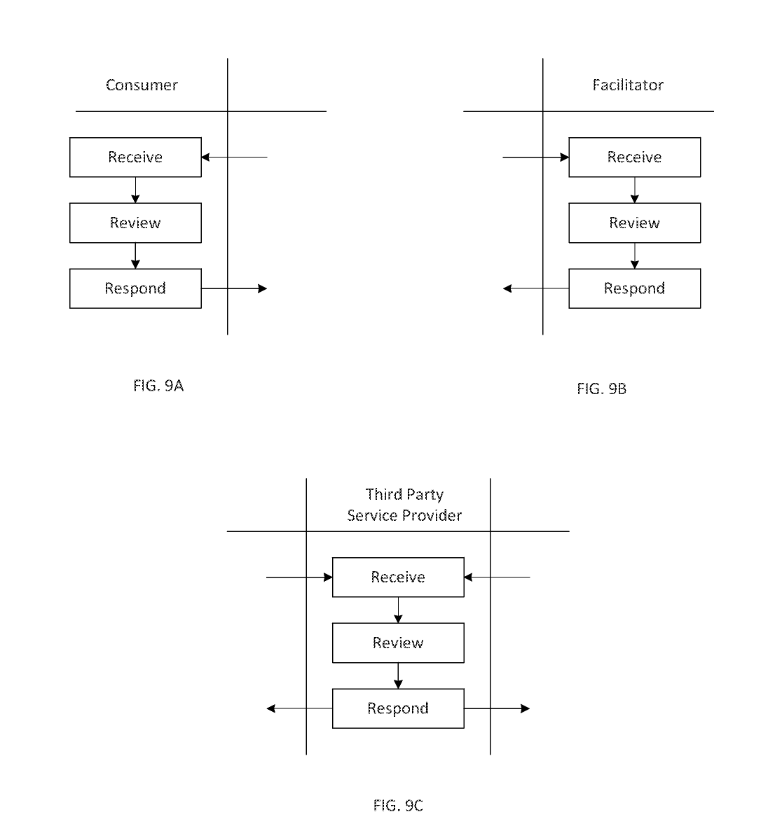

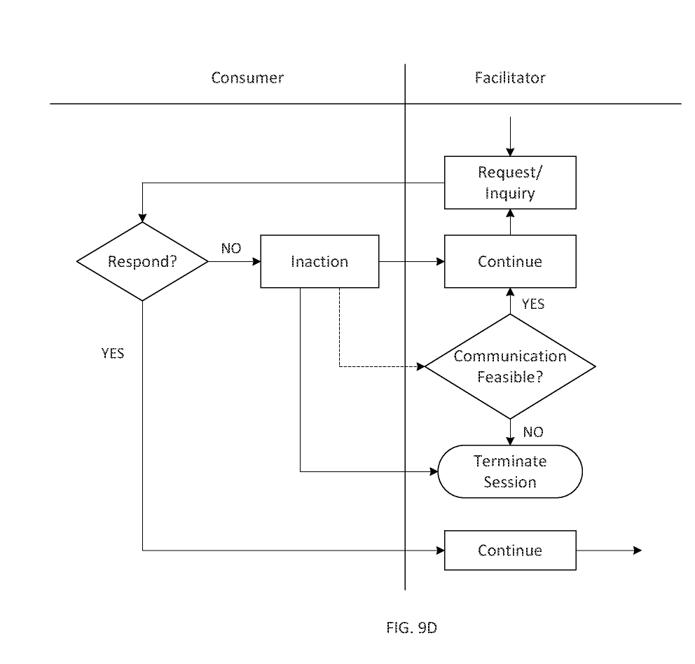

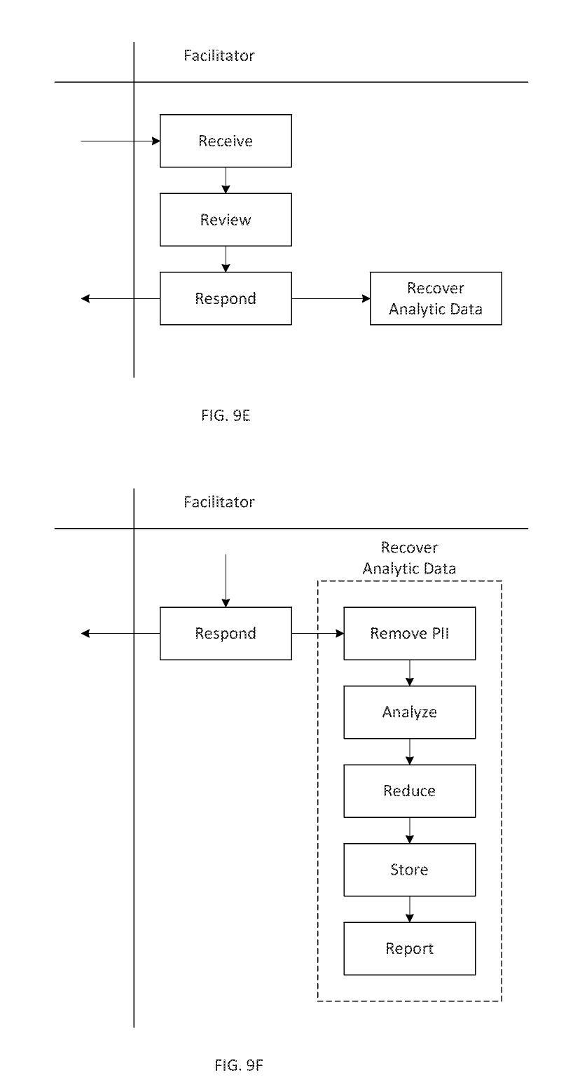

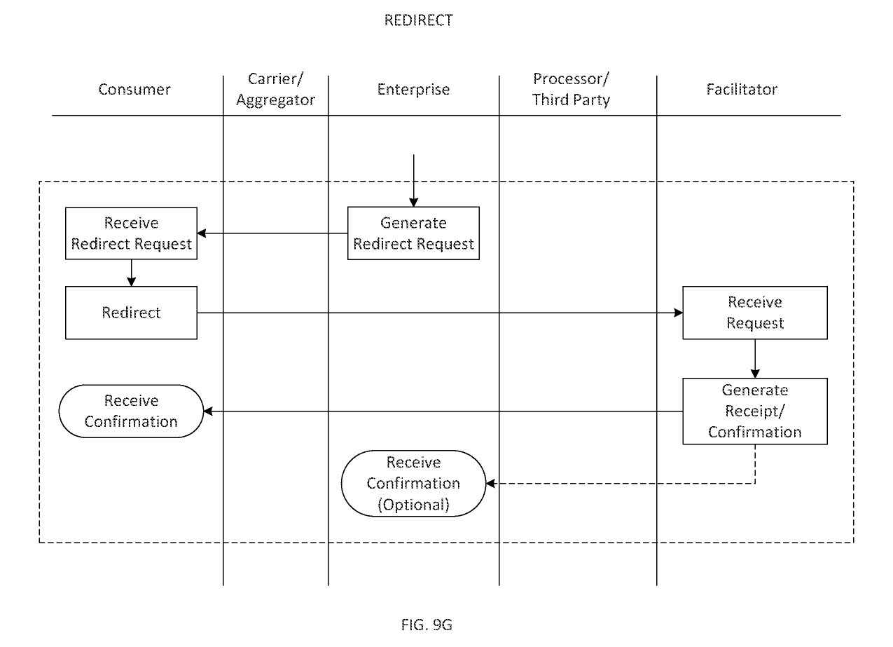

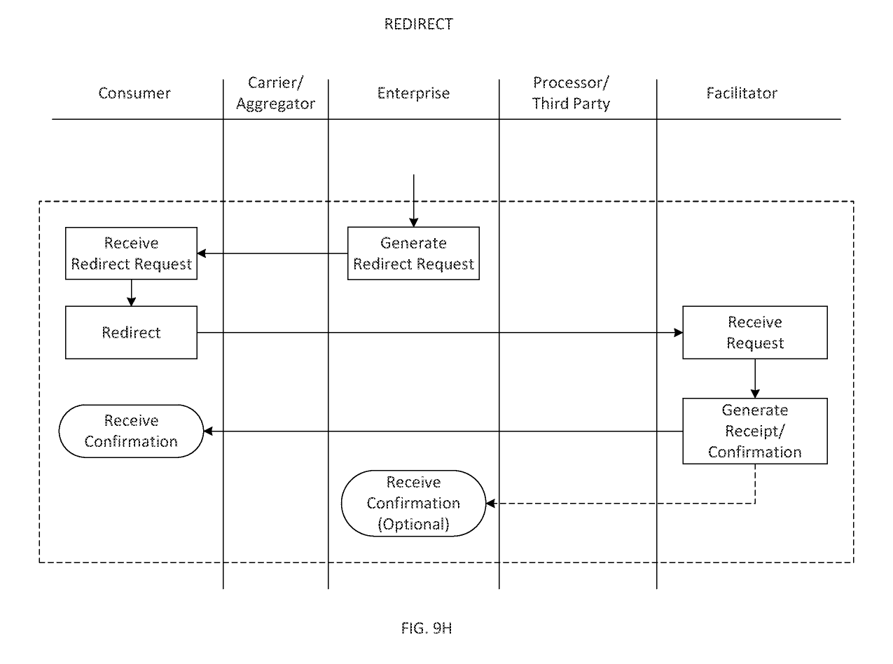

FIGS. 9A through 9C show a schematic representation of the processing of messages by the consumer and the facilitator (and/or third-party service provider). According to an exemplary embodiment, the processing may comprise three steps; the message is first received and then reviewed, and a response can be sent.

Referring to FIGS. 9D through 9G, schematic diagrams of conditions of a consumer interaction are shown. As shown, a consumer expected to provide a response may provide a response to continue the interaction/transaction, may terminate the session (by intent or because of an external event, such as loss of communication), or may be “inactive” (providing neither an indication to continue or an indication to terminate). If an “inaction condition” is identified by the facilitator (i.e. upon a determination that inactivity for a specified period of time indicates inaction) the facilitator may review and make an evaluation of how to proceed with the consumer. The facilitator in a particular interaction, upon determination of “inaction” by the consumer, may present to the consumer a response determined to be fit for the condition. For example, a loan pay-out offer sent to a consumer may be valid (or open) for a number of days (e.g., three). If the consumer does not act within the time period specified by the enterprise, the facilitator may by monitoring the time period determine an “inaction condition.” Inaction may follow from an intent of the consumer to continue (coupled with indecision as to how to continue), a temporary inability of the consumer to respond (e.g. lost signal/coverage by the mobile device), distraction or inattention by the consumer, etc. A response by the facilitator may be to repeat a prior communication to the consumer, to enquire if the consumer wants to continue the interaction/transaction, to assess (if possible) whether communication with the consumer is possible, to make another inquiry to the consumer; the interaction may be terminated/closed and ended. The time of delay/inaction by the consumer may be considered in the determination of an appropriate response. Analytic data about the interaction/transaction may be used by the facilitator or enterprise or others to modify, improve, optimize, etc. or to build a knowledge base for on-going and future evaluation, analysis, interaction design, interface design, parameter settings, etc. Analytic data may comprise various data of consumer responses and/or activity or inactivity, such as items of apparent interest, dollar amount or value of transactions, outcomes of interactions/transactions, durations of transactions, points or areas in which there is delay or termination, etc. (Analytic data may be stripped or “sanitized” of PII or other content that is sensitive or unnecessary before it is recovered/stored/transmitted and used for analytical purposes.) Analytical data can then be processed, organized, analyzed, used, stored, reported, published, commercially vended, etc. by or for the enterprise or another entity.

Referring to FIG. 9G, an exemplary embodiment of a process for redirecting messages is shown. According to any exemplary embodiment, the system and method will use conventional or any existing method for a “redirect” of a message or other communication over the network/internet. The “redirect” may be initiated by the enterprise after the completion of another process, as shown for example in FIG. 6A. The consumer device receives the redirect request and redirects a message (e.g. transmitted response/reply and/or request) to the facilitator (or other intended recipient of the message) who, upon receipt of the request, generates a receipt/confirmation that is sent to the consumer (i.e. displayed on the consumer device) and optionally to the enterprise.

According to an exemplary embodiment, considerations of security in the handling of PII and related information of sensitivity (e.g. PII, PHI, PCI, ESD, etc.) may allow the facilitator to structure interactions for an enterprise/client with consumers/customers in a manner intended to minimize risk and/or exposure of information that is private, personal, sensitive, secured, etc. See, e.g., FIG. 19 (TABLE 1).

According to an exemplary embodiment, for example, interactions with a consumer may be conducted in a session in which data/information exchanged in the interaction is not stored after the session has concluded, as shown in FIG. 10A. A session may include multiple instances of processing messages (as shown in FIG. 9A through 9C). A typical session (such as in FIG. 10A) begins with an inquiry that is sent by the first party (e.g. the facilitator). The second party (e.g. the consumer) receives the inquiry, reviews it and responds to it by sending data or information. The first party again receives and reviews the data or information and sends an appropriate response. The exchange may happen multiple times (e.g. two to four times or more). At the close of the session, the facilitator will destroy session data and retain only a record of the interaction (e.g. call data record or equivalent for an SMS/text or other messaging session). A notification may be sent to the other party (e.g. consumer) at the end of the session. The other party may then follow up with another/next action in the general transaction, or the end of the session may also end the general transaction. A single transaction may include multiple sessions (and the creation of one or more sets of session data, see FIG. 19). Referring to FIG. 10B, the interaction/transaction with the consumer can be facilitated by the allocation of the facilitation function between the facilitator and the third-party service provider as shown according to an exemplary embodiment. As shown in FIGS. 10A and 10B, the interaction/transaction involves facilitation on behalf of the enterprise that can be managed by the facilitator alone or the facilitator and the third-party service provider (working by allocation of the required functions). As indicated, the facilitation of an interaction/transaction (including related communications) involves the performance of various functions. According to an exemplary embodiment (shown in FIG. 10A) the functions of facilitation may be performed by the facilitator (i.e. one entity). According to an alternative exemplary embodiment (shown in FIG. 10B) the functions of facilitation may be performed by the facilitator and a third-party service provider (i.e. an additional entity). The facilitator and the third-party service provider co-facilitate the interaction/transaction with the consumer on behalf of the enterprise. The facilitator may operate as the primary facilitator and the third-party service provider may operate as the secondary facilitator. For example, according to an exemplary embodiment, the facilitator (e.g. primary facilitator) may provide APIs that can be used and accessed by the third-party service provider (e.g. secondary facilitator) in the performance of the function of facilitation of the interaction/transaction. According to preferred embodiments, the facilitator and the third-party service provider will be able to share and interchange files, data and programs/interfaces, etc. (e.g. over a network connection or by other protocols). According to a particularly preferred embodiment, the facilitator and the third-party service provider will follow similar routines and present data to the consumer in a consistent manner (i.e. the identity of the particular entity interacting with the consumer during the interaction/transaction is transparent to the consumer).

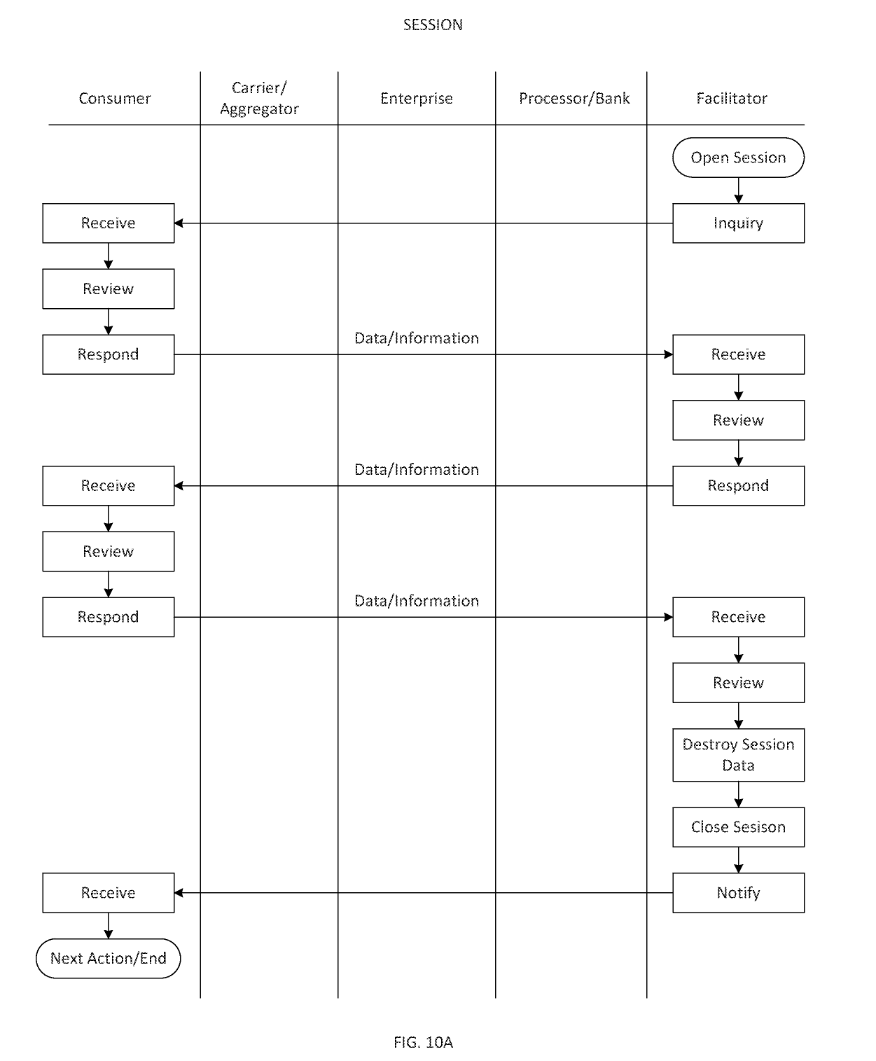

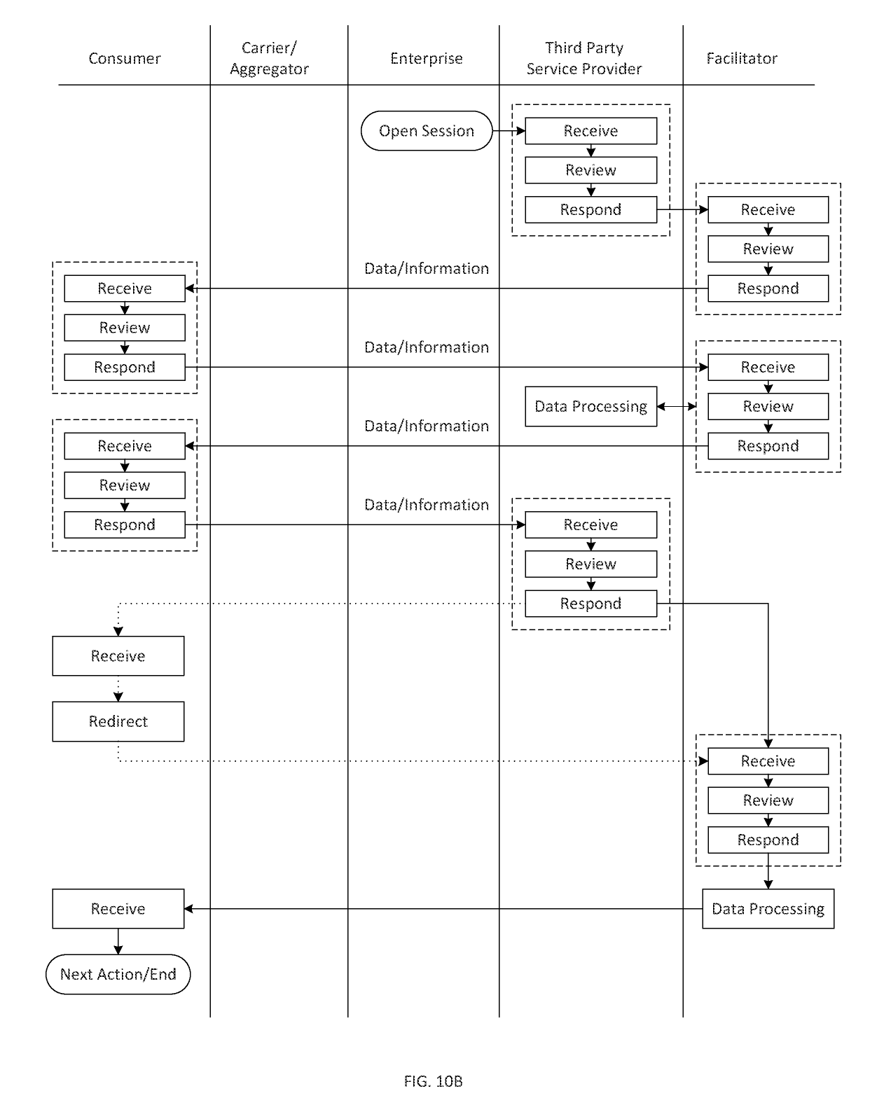

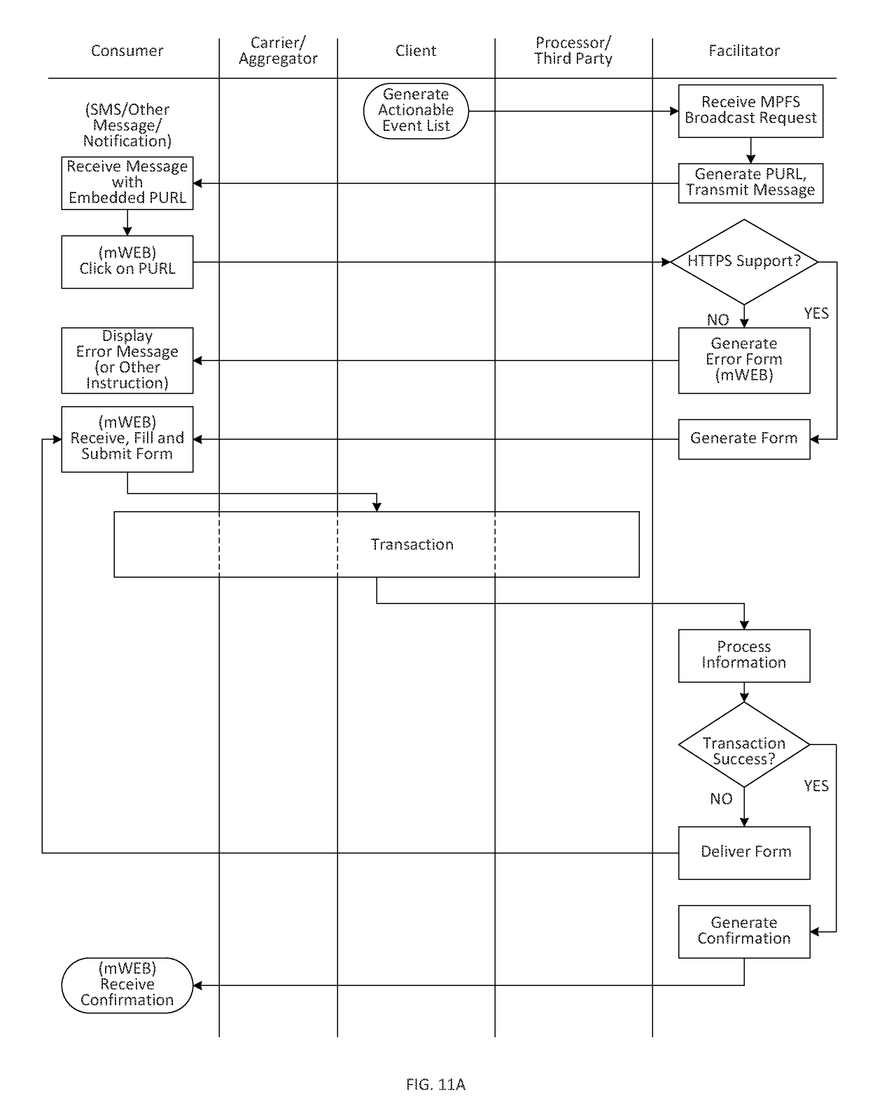

FIG. 11A shows an example of a typical embodiment that begins when the enterprise generates an actionable event list and sends it to the facilitator with a request for a Multi Path Facilitation System (MPFS) broadcast. The facilitator processes the information to generate a message or a group of messages that are sent to specified consumers in the form of a text message (SMS) or another type of message. The message may include an embedded PURL link.

The consumer may “click on” the PURL link (e.g. access/activate a file or web based action over a network) to send a response, triggering a request for a document or a form (i.e. a file) from the facilitator. The facilitator then checks for secure transaction support (e.g. HTTPS Support). If secure transactions are not supported, the facilitator may generate an error message or other instruction for the consumer. If the facilitator finds that there is support for secure transactions, it may generate a form and send it to the consumer (FIG. 11A).

After opening the message, the consumer may fill out the “form” with the information requested in/on the form and submit a completed form/file to the enterprise to initiate the transaction (see FIG. 11A). After the transaction is complete the information is sent to the facilitator for further processing. If the transaction was successful, the facilitator generates a confirmation and sends it to the consumer device. If the transaction was not successful, the facilitator redelivers the form to the consumer, who may then attempt the transaction again. The messages may be delivered, for example, via mobile web (mWeb) (FIG. 11A) or using APIs (FIG. 11B).

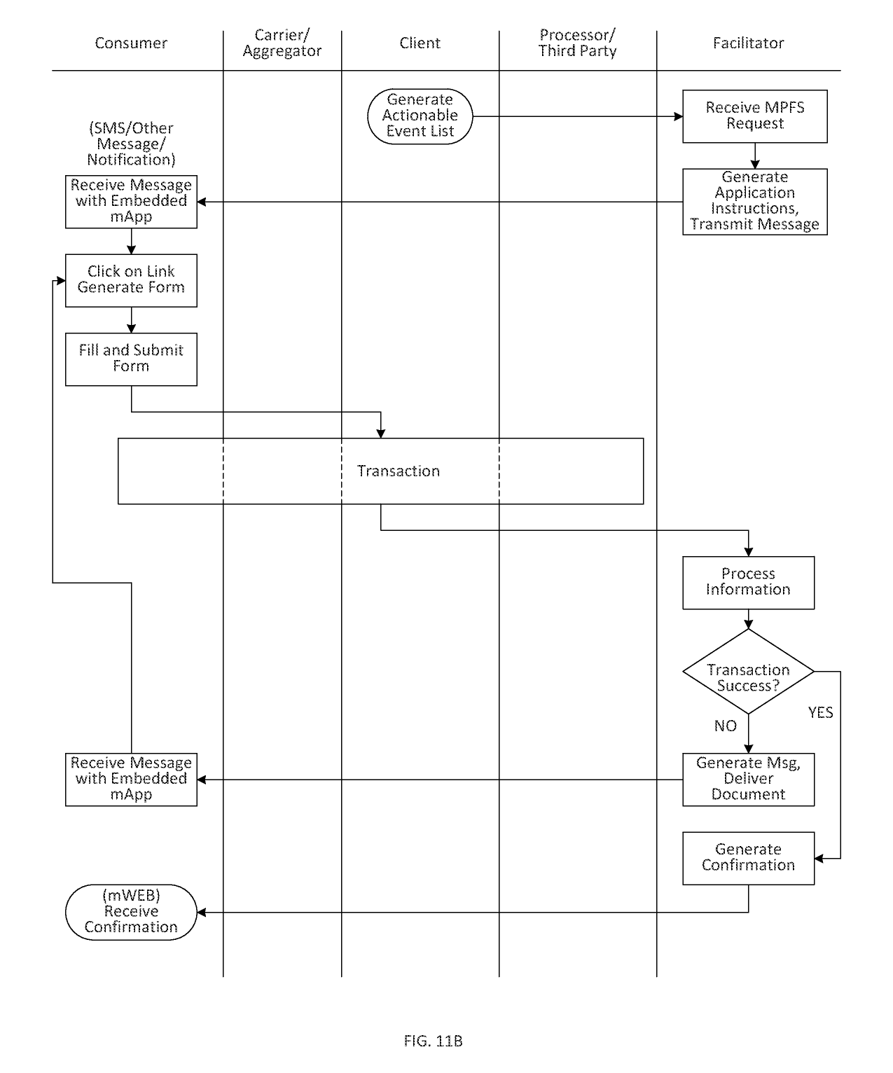

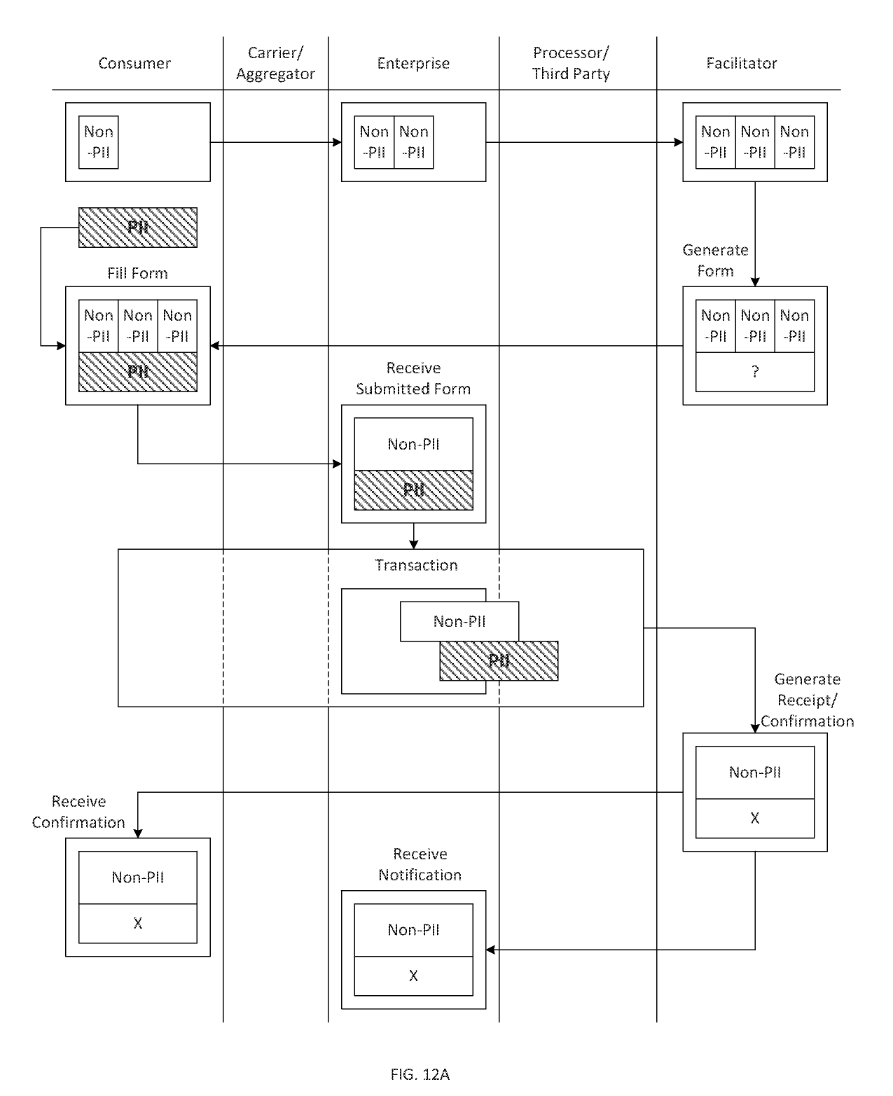

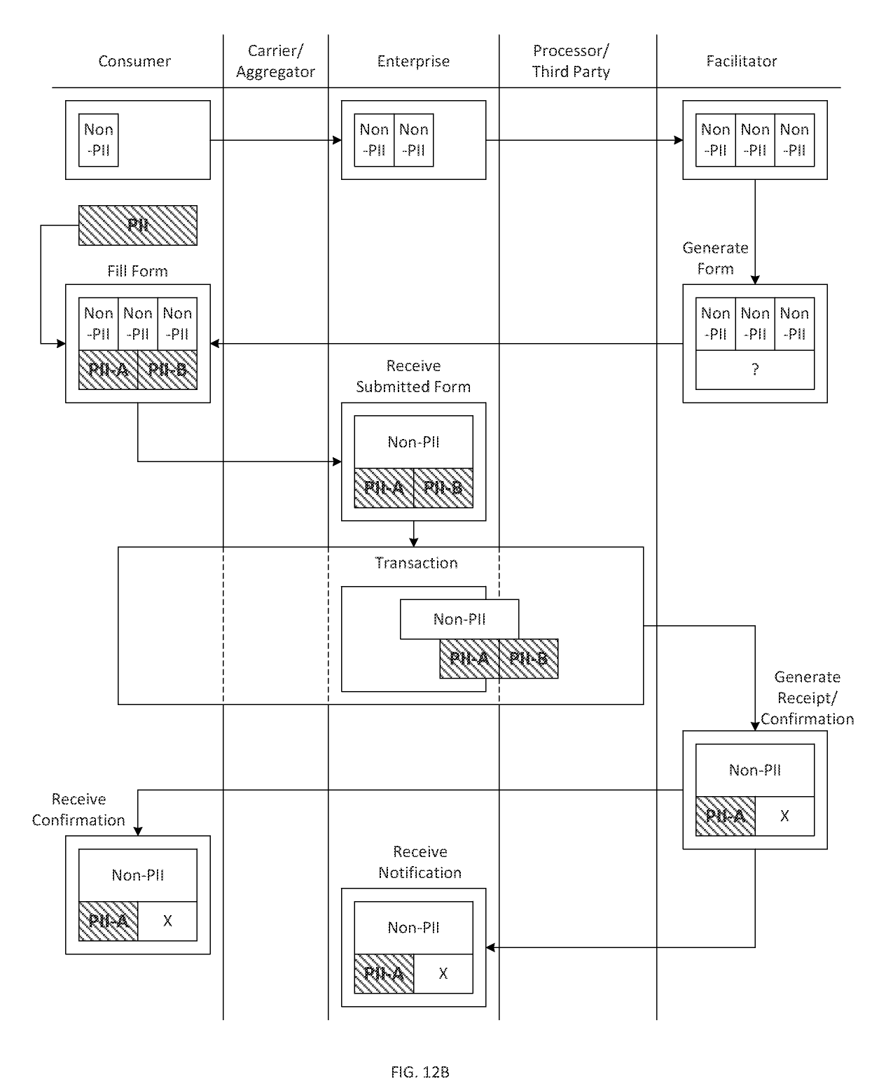

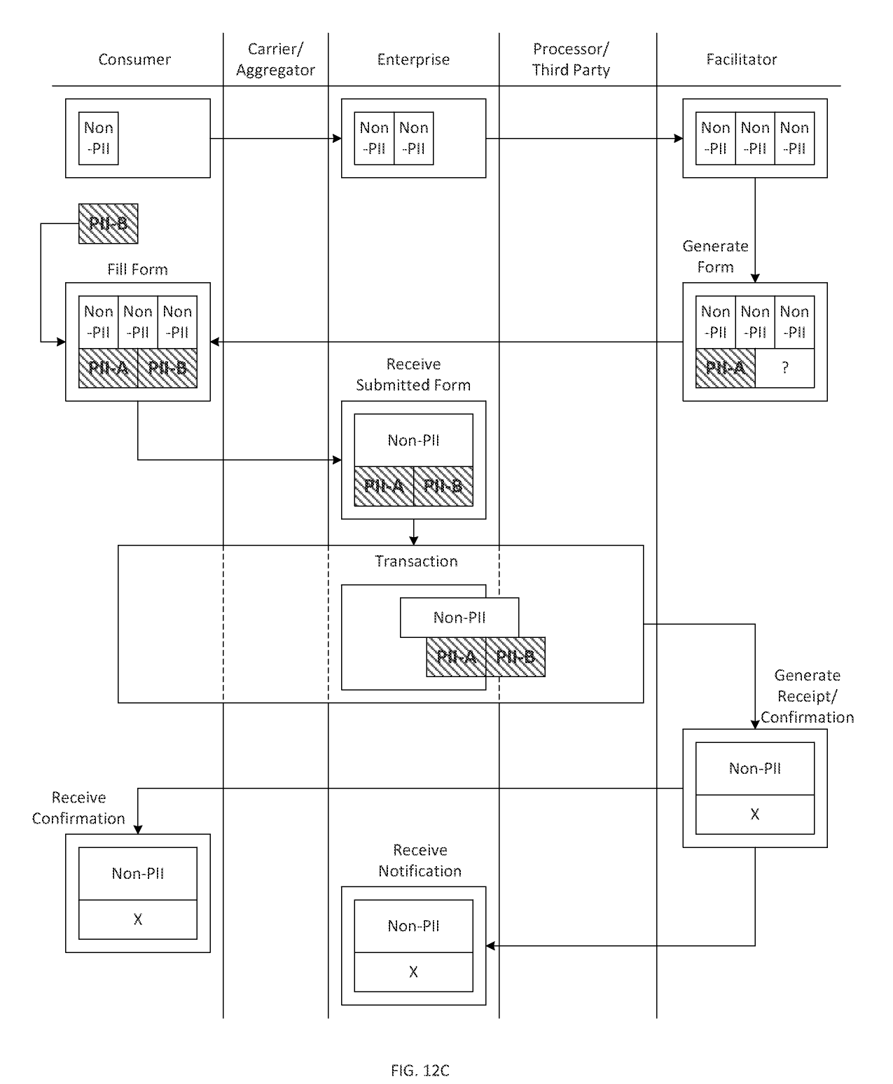

According to an exemplary embodiment, the facilitator may structure the transactions to minimize the sharing of PII and related information of potential sensitivity (e.g. PHI, PCI, ESD, etc.). For example, FIG. 12A shows schematically an exemplary embodiment of an interaction/transaction where the consumer submits only non-PII (non-personally identifiable information) to the enterprise, who then adds some non-PII information that it has about the consumer (e.g. relating to prior participation in campaigns) and sends it to the facilitator. The facilitator may add more non-PII information that it has available (e.g. general or specific information gathered about the consumer or other information) and then proceed to generate a message with a fillable form that requests PII (among other information) from the consumer. At this point the consumer is the only person or entity in possession of the PII of the consumer in the transaction (apart from other stored PII). The consumer receives the form and can fill out or provide the PII. Once the consumer submits the form with the non-PII and PII, the information stays in the possession of the consumer, enterprise and financial institution, and can be used to process the transaction. According to an exemplary embodiment, the facilitator does not participate in the transaction as to receive any of the PII provided by the consumer. After the transaction is complete, a request for a receipt (including non-PII only) is sent to the facilitator, who then generates a receipt/confirmation for the consumer and notifies the enterprise of the success of the process. According to an exemplary embodiment, unnecessary sharing of the consumer-provided PII is avoided or minimized/reduced; the facilitator does not have to manage and protect any PII that it has not received or that is not in its possession.

According to alternative embodiments, as shown schematically in FIGS. 12B and 12C, the PII may comprise two groups of PII (e.g. shown schematically as PII-A and PII-B), which may be handled differently during the process of completing the transaction/interaction. For example, in FIG. 12B, the consumer provides PII (comprising PII-A and PII-B); after the PII has been used in the transaction, PII designated as PII-A is forwarded to the facilitator along with a request for a receipt/confirmation and is managed by the facilitator; PII designated as PII-B (e.g. credit card information) is deleted or managed separately but is not in the possession of the facilitator. FIG. 12C shows schematically another example, where the facilitator provides a part of the PII (PII-A, e.g., account number) and the consumer provides another part of the PII (PII-B).

FIG. 19 (TABLE 1) shows how in a schematic and general representational form that different types of information may be handled by the facilitator (and other participants in a transaction/interaction) according to different procedures/processes, according to an exemplary embodiment of the system and method. Information in the TABLE is grouped into eight general categories; general, carrier, client, campaign, financial, security, health care related and transactional. The columns of the table show information type (e.g. name, phone number, password, etc.), information security type (card holder information (PCI), enterprise secured data (ESD), personally identifiable information (PII) and protected health information (PHI)) and potential entities involved in a transaction or process. An example of how each item of information may be used, managed, stored and/or transported, etc. by each entity is indicated.

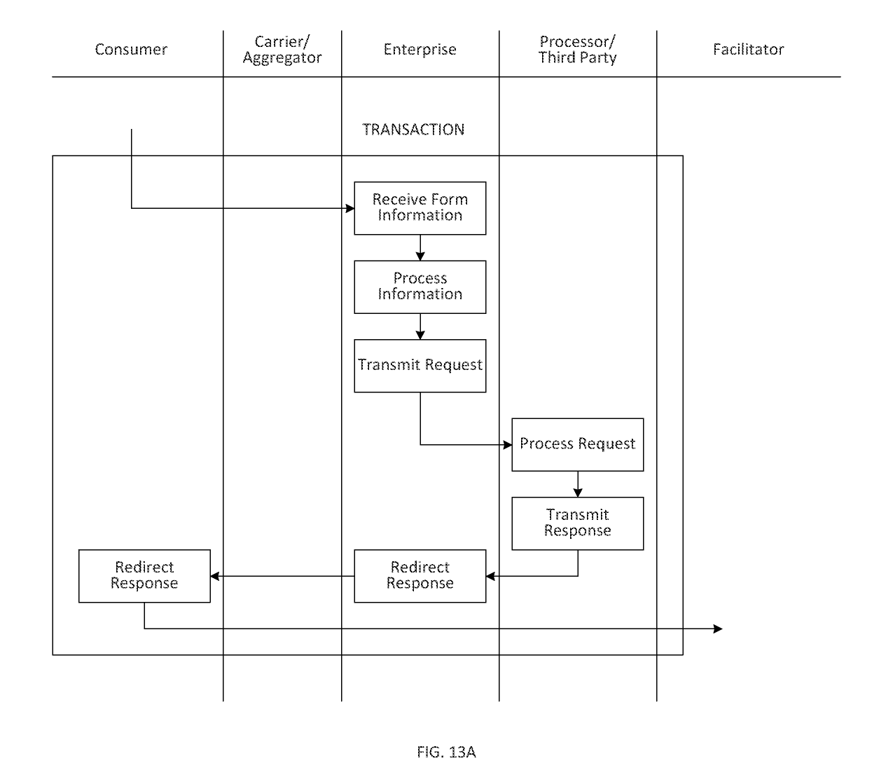

An exemplary embodiment of a financial transaction is shown in FIG. 13A. According to an exemplary embodiment, after the consumer submits information to the enterprise (as seen in FIGS. 7, 11A, 11B, 12A through 12C), the enterprise processes the information and sends a request to a processor or a financial institution (e.g. bank) for further processing. The processor/bank processes the request and transmits a response to the enterprise. The enterprise sends a redirect request (e.g. by using conventional or other internet/web page programming or protocol) with information about the transaction to the consumer device, and the device redirects the information to the facilitator. An example of a financial transaction is a credit card payment through a bank to complete a purchase. Some transactions do not involve a third party, but are processed between the consumer and the enterprise, as shown in FIG. 13B. In FIG. 13B the enterprise receives and processes the form information and then generates and transmits a response to the consumer. The consumer mobile device redirects the response (e.g. to the facilitator).

According to an alternative embodiment, the facilitator may structure and format the redirected communications to and from the mobile device of the consumer/customer (e.g. by using templates or webforms/webpages). The facilitator may manage the “look and feel” (e.g. consistency) of communications to and/or displayed upon the mobile device (i.e. rather than having the communication appear as from or sent by the processor/financial institution). For example, the facilitator may prepare a template for the processor to use and/or may communicate directly to the mobile device such information as status information for the transaction, including a notification that payment has been “approved” and/or a receipt for the transaction (e.g. if provided with notice of successful execution of the redirect request or otherwise upon receipt of such information from the processor); the facilitator may also prepare a template for the processor to use for any other communications to the mobile device, such as another payment form if required for the consumer/customer to correct an error or omission or otherwise to complete the transaction successfully.

According to any exemplary embodiment of the system and method, in order to facilitate the convenience of the transaction and in an effort to reduce potential data entry errors, the facilitator may pre-populate with available information any webform that is presented to the mobile device with some portion or all of the information that is requested from the consumer/customer or otherwise required to be presented to the enterprise or processor; the consumer/customer may then verify the information that has been pre-populated in the webform and update or include any other information that is required for accuracy and completeness for the transaction. The facilitator may maintain and update databases containing any such information with authorization of the person using the mobile device. According to any exemplary embodiment, the facilitator will attempt to structure the transaction to provide a level of convenience, accuracy, speed and data security that is appropriate for the needs and objectives of the enterprise and its customers.

FIGS. 14A through 14G are exemplary embodiments relating to different uses of the system and method; secure transactions are shown by a dashed-line box. Referring to FIG. 14A, the system and method can be used in a customer loyalty program. A web coupon is generated and forwarded to the consumer (i.e. customer), who then redeems the coupon in order to receive a discount. A third party processor (e.g. a convenience store, retail pharmacy, other enterprise, etc.) accepts the coupon (e.g. a manufacturer's coupon), provides the consumer with the discount, notifies the enterprise and redeems the claim from the enterprise. A redirect request is sent as a reply to the consumer device, which redirects the message to the facilitator. The facilitator generates a receipt/confirmation and sends it to the customer. According to the exemplary embodiments, secure transactions are used where shown (schematically) in FIG. 14A by a dashed-line box.

Referring to FIG. 14B, the system and method can be used in a transaction that involves an electronic payment by the consumer. The transaction may begin either by the consumer or the enterprise generating a request that is processed by the facilitator. The facilitator may then generate and send a message with a PURL to the consumer, who can click (or activate an action) on the embedded link (e.g. using conventional internet or web programming or protocol). Clicking on the link sends another request to the facilitator, who then generates a web form with payment information. The form is displayed on the consumer's device, and the consumer can submit the payment by filling in the requisite fields in the form (e.g. credit card number, security code, etc.). The filled-out form is sent to the enterprise for processing. The enterprise may process the information or may use a third party processor (e.g. bank) to have it processed. After the payment is processed, a redirect request is sent as a reply to the consumer device, which redirects the message to the facilitator. If the payment was approved, the facilitator will generate a receipt/confirmation and send it to the customer. If the payment was not approved, the facilitator will generate a new web form and send it to the consumer to allow the consumer to correct any errors or otherwise attempt to complete the transaction.

Referring to FIG. 14C, according to an exemplary embodiment, the system and method can be used to collect sensitive information from consumers for example in conjunction with a registration or by an employer collecting employee information. The process is generally similar to that shown in FIG. 14B. The web form generated by the facilitator requests the consumer to provide sensitive information to be submitted to the enterprise or to a third-party entity (e.g. data processor, facilitator, co-facilitator, etc.) to process the information. If the transfer of information was successful, the facilitator generates a receipt/confirmation that is sent to the consumer. If the transfer was not successful, the facilitator generates a web form and sends a message (e.g. with the form or file) to the consumer for a re-attempt of the next step in the transaction.

Referring to FIG. 14D, the system and method can be used in the hospitality industry to make a booking or a reservation. According to an exemplary embodiment, the process is generally similar to that shown in FIG. 14B. The facilitator generates a web form for the booking or reservation information, which is completed by the consumer and sent to the enterprise. The enterprise processes the booking information and determines if a payment is required. If a payment is required, the payment request can be processed as in FIG. 14B. If no payment is required, the enterprise generates a redirect request that it sends to the consumer device, which redirects it to the facilitator. The facilitator generates a receipt/confirmation that is sent to the consumer.

Referring to FIG. 14E, the system and method can be used to confirm an appointment (e.g. a medical appointment). According to an exemplary embodiment, the enterprise (e.g. a medical clinic) sends a request to the facilitator, which processes the request and generates a message with a PURL that it sends to the consumer. The consumer can “click on” the link (e.g. access/activate a file or web based action over a network), generating another request to the facilitator. The facilitator then generates a web form with information regarding the appointment that is displayed on the consumer device. The consumer can choose to either cancel or confirm the appointment. After processing the information the enterprise generates a redirect request that it sends to the consumer device, which redirects it to the facilitator. The facilitator generates a receipt/confirmation that is sent to the consumer.

Referring to FIG. 14F, the system and method can be used to ensure compliance with a medical treatment regimen. According to an exemplary embodiment, the enterprise (e.g. a medical clinic) sends a request to the facilitator, which processes the request and generates a message with a PURL that it sends to the consumer/patient. The consumer can “click on” the link (e.g. access/activate a file or web based action over a network), generating another request to the facilitator. The facilitator then generates a web form with information regarding the treatment regimen that is displayed on the consumer device. The consumer can generate a reply including the pertinent medical data (e.g. answers to questions on the form about taking medication) and send it to the enterprise. The enterprise will process the information and optionally make recommendations or adjust the treatment regimen. After processing the information the enterprise generates a redirect request that it sends to the consumer device, which redirects it to the facilitator. The facilitator generates a confirmation that is sent to the consumer including possible instruction or recommendation regarding the treatment.

Referring to FIG. 14G, the system and method can be used to monitor a clinical trial. The process is generally similar to that of FIG. 14F, with the exception that after sending a message to the consumer/patient, the facilitator will monitor the response time, and if the consumer/patient has not responded within a set time, will prompt the consumer with a new message. The consumer will include the pertinent medical data on the web form and send it to the enterprise for processing. The enterprise may optionally make recommendations or adjust the treatment regimen. After processing the information the enterprise generates a redirect request that it sends to the consumer device, which redirects it to the facilitator. The facilitator generates a confirmation that is sent to the consumer including possible instruction or recommendation regarding the treatment.

### Facilitation System

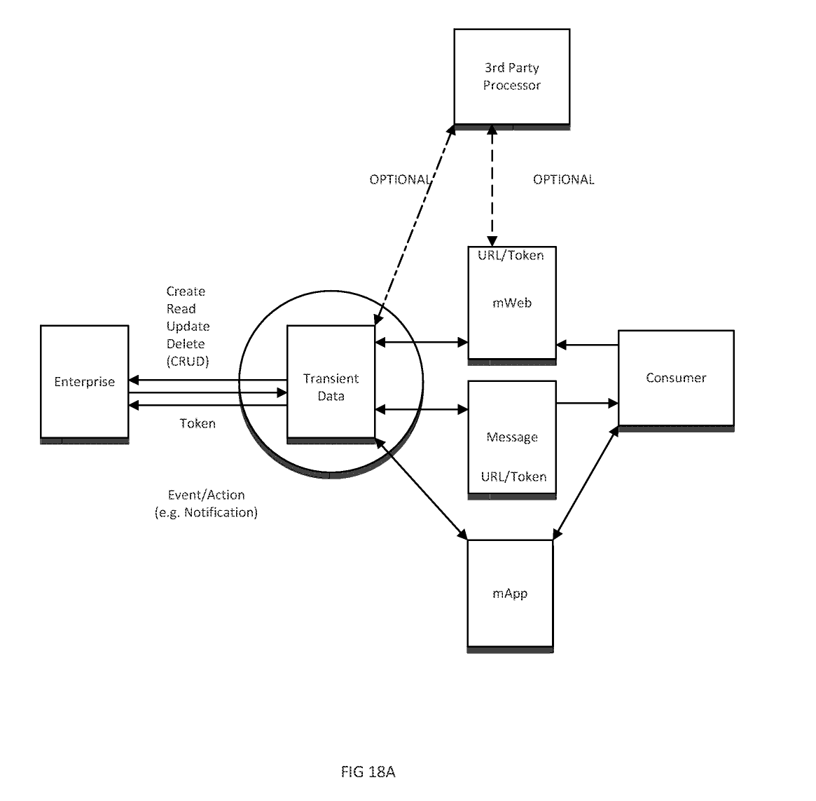

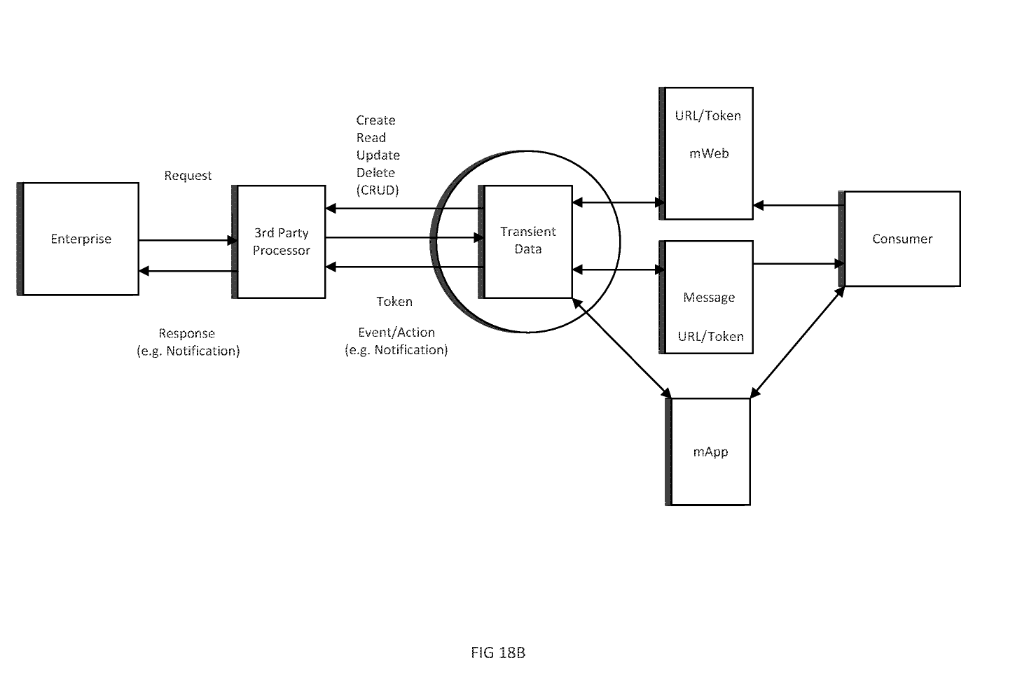

Referring to FIGS. 5D, 15, 18A and 18B, the implementation of the facilitation system for a transaction or interaction between an enterprise and a consumer using a mobile device is shown. According to a preferred embodiment, a transaction or interaction can be designed or structured to involve a facilitator (e.g. having functional capabilities such as shown in FIGS. 5A and 5D) and/or other entities including third parties (e.g. credit card companies or banks, other entities that may facilitate some portions of the transaction or interaction, etc.); the design or structure of the transaction flow and degree and nature of involvement of entities may be configured as determined to be appropriate for the particular transaction or according to other criteria, preferences, intent or needs that may be considered; the types or manner of use of communication channels may also be part of the design or structure of a transaction. As shown schematically in FIGS. 18A and 18B, in the facilitation of a transaction by use of the facilitation system (e.g. shown in FIG. 5D), a third-party processor or entity may by design be configured to have optional involvement (FIG. 18A) or direct involvement (FIG. 18B) in the facilitation of the transaction between the customer and the enterprise without requiring substantial modification of the information flow (e.g. creation, reading, updating and deleting information), the handling and storage of transient nature data, the use of communication channels (e.g. messaging, mWeb, mApp), the management of security, notifications to be provided, or other aspects of the transaction flow.

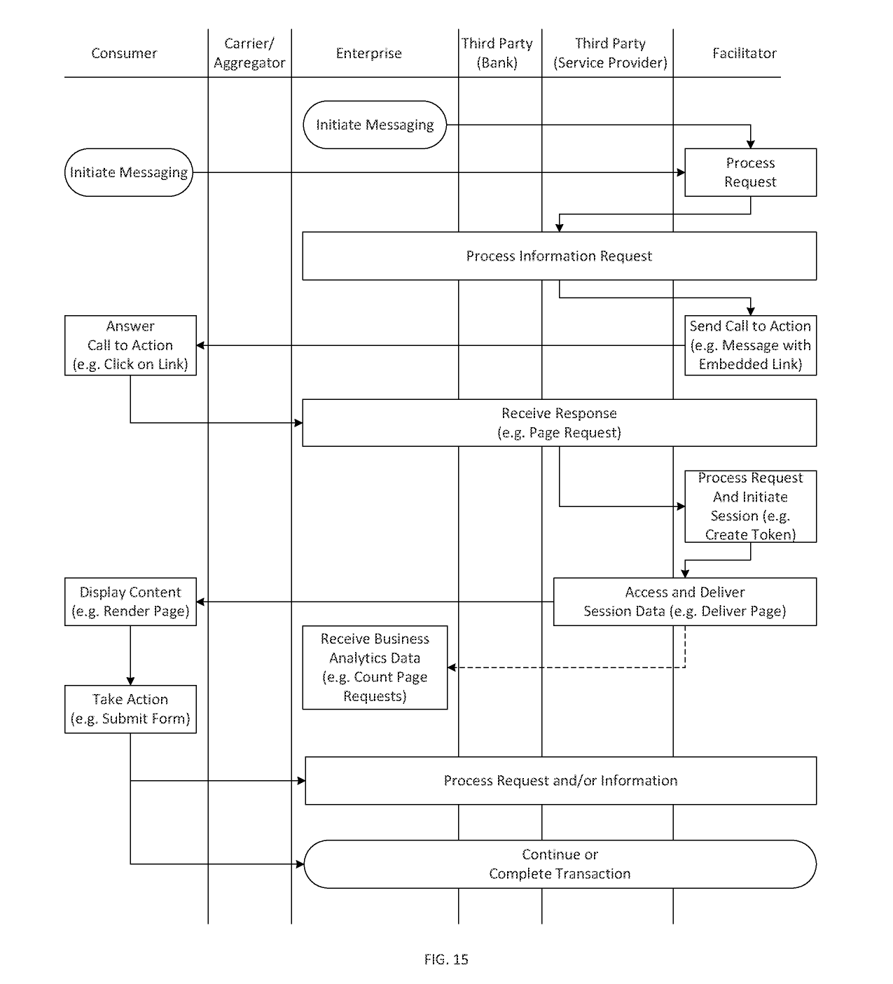

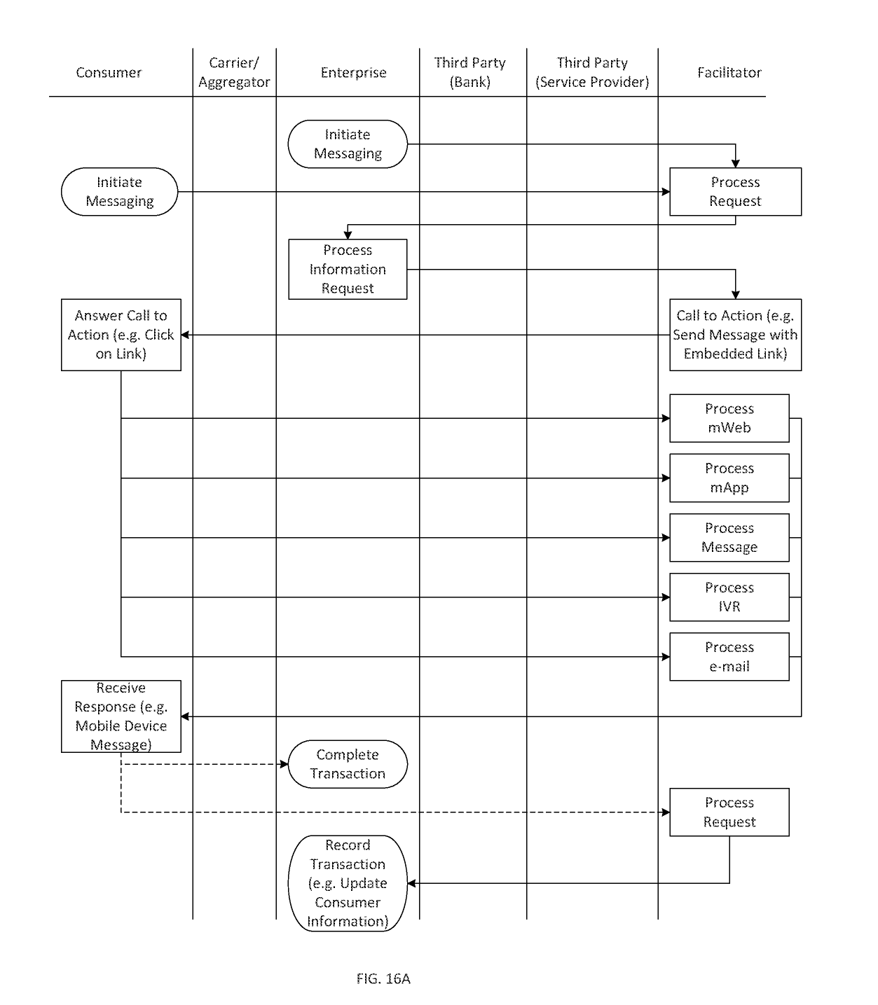

According to the exemplary embodiment shown in FIG. 15, a facilitator or a third-party service provider operating as facilitator and/or using the facilitation system (e.g. as shown in FIG. 5D) will facilitate the interaction between the enterprise and the consumer. As indicated, according to an exemplary embodiment, either the enterprise or the consumer may initiate the interaction with a message or other communication (or according to an alternative embodiment a facilitator may initiate the interaction); the facilitator will process the message or request initiating the interaction (and other entities may also process the request or related information) and will respond with a call to action by the consumer (e.g. sending a message to the consumer with an embedded link). The consumer will answer the call to action with a response that can be reviewed by the facilitator (or other entities) and processed to initiate a session (e.g. including the creation of a token that can be used to identify and maintain association of the consumer with the particular interaction or transaction). Data for the session will be accessed and obtained by the facilitator and then delivered to the consumer for display on the mobile device (e.g. as a “page” of data or content). Business analytic data (e.g. that a consumer has made a page requests or other information about the consumer or interaction) may be provided to the enterprise by the facilitator for each session (and/or in a cumulative or periodic interval or as-requested or agreed upon). The consumer may take action by completing and submitting information (e.g. by submitting a form); action taken and/or information provided by the consumer may then be processed; further actions and interactions (e.g. involving one or more of entities such as a facilitator, a third party financial entity such as a credit card vendor or bank, or the enterprise, or a third party service provider assisting the enterprise or otherwise assisting with the transaction) may follow to continue or complete the transaction between the consumer and the enterprise. According to other exemplary embodiments, facilitation of the transaction or interaction may include one or more of the performance of functions such as shown in FIG. 5D or other related functions performed by involved entities such as a facilitator or third parties.

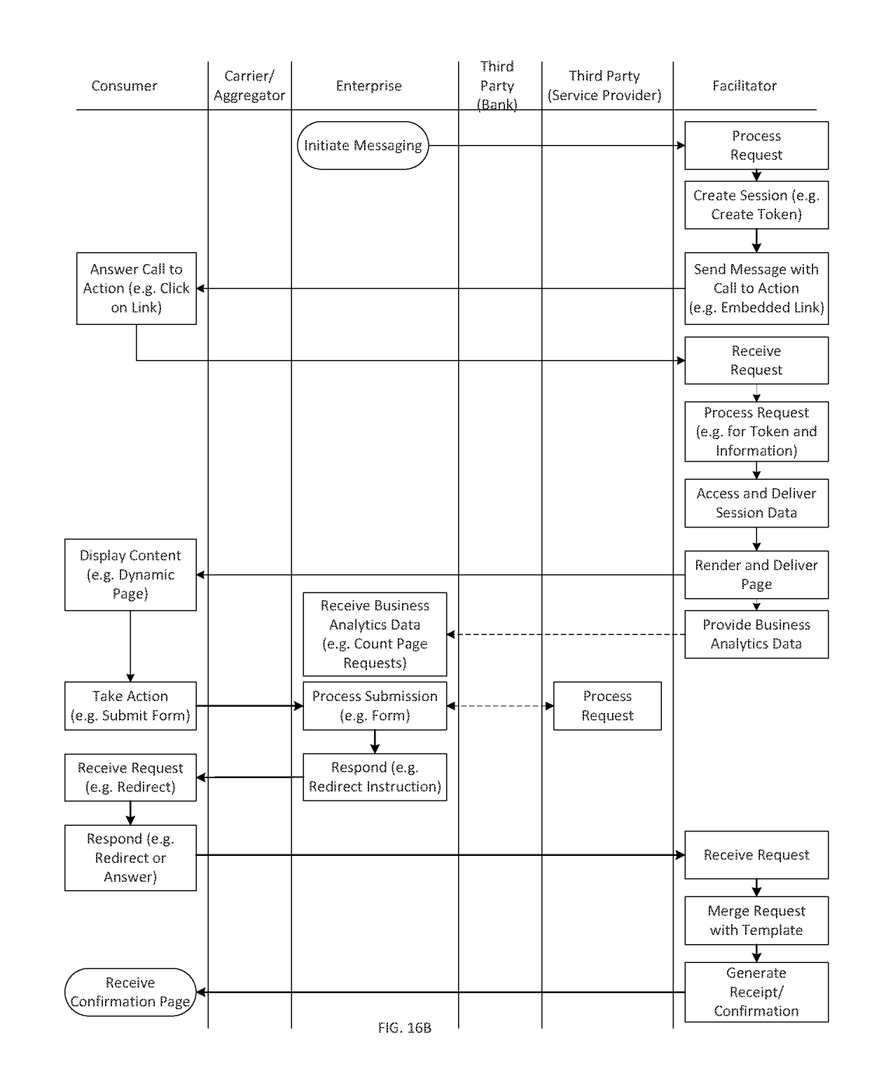

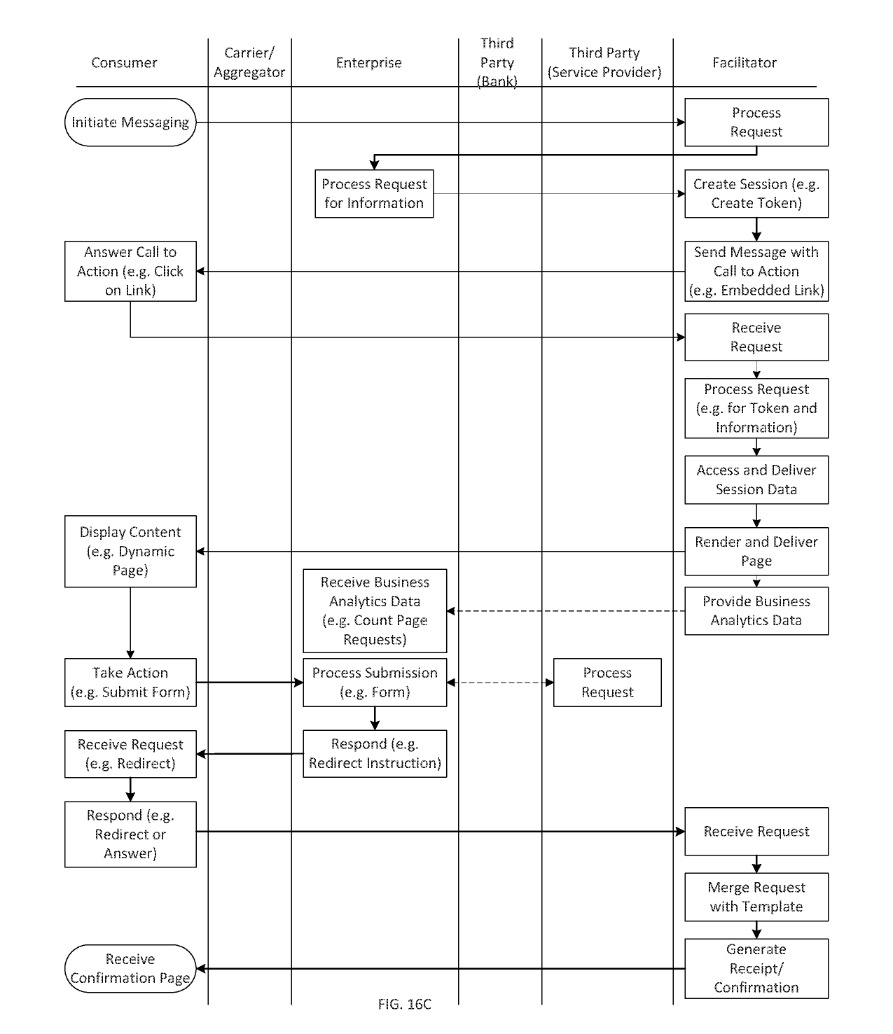

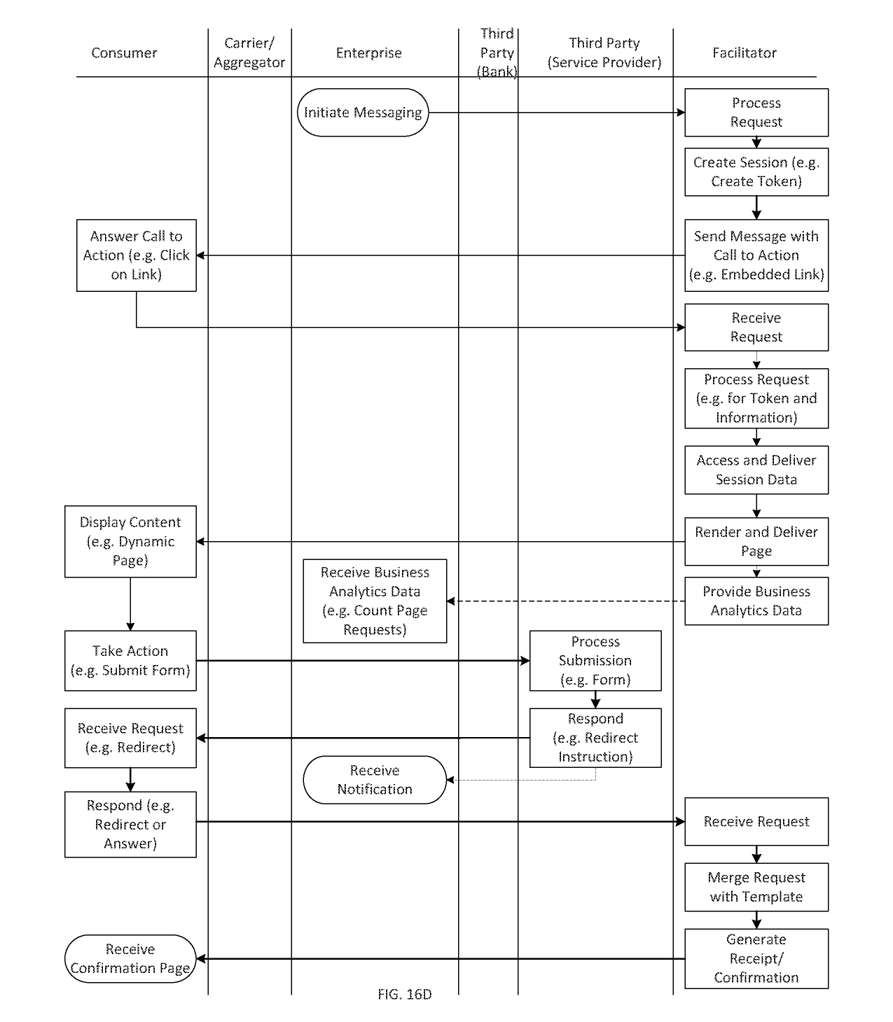

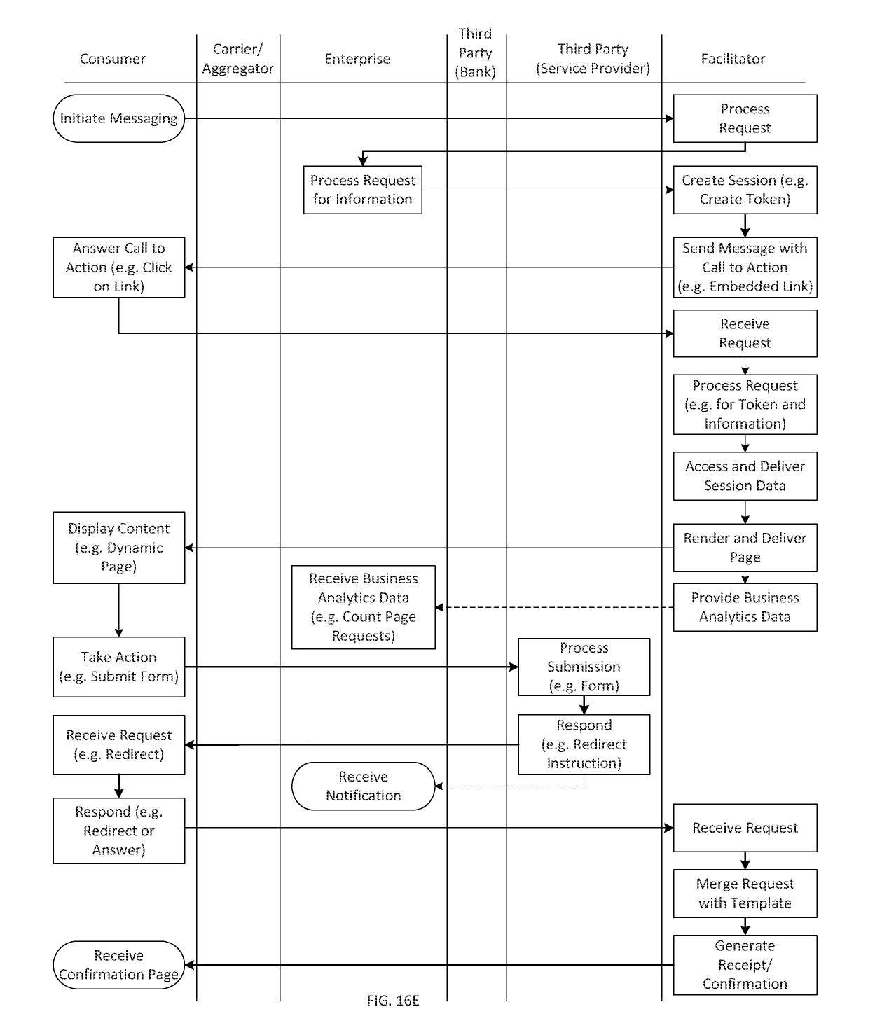

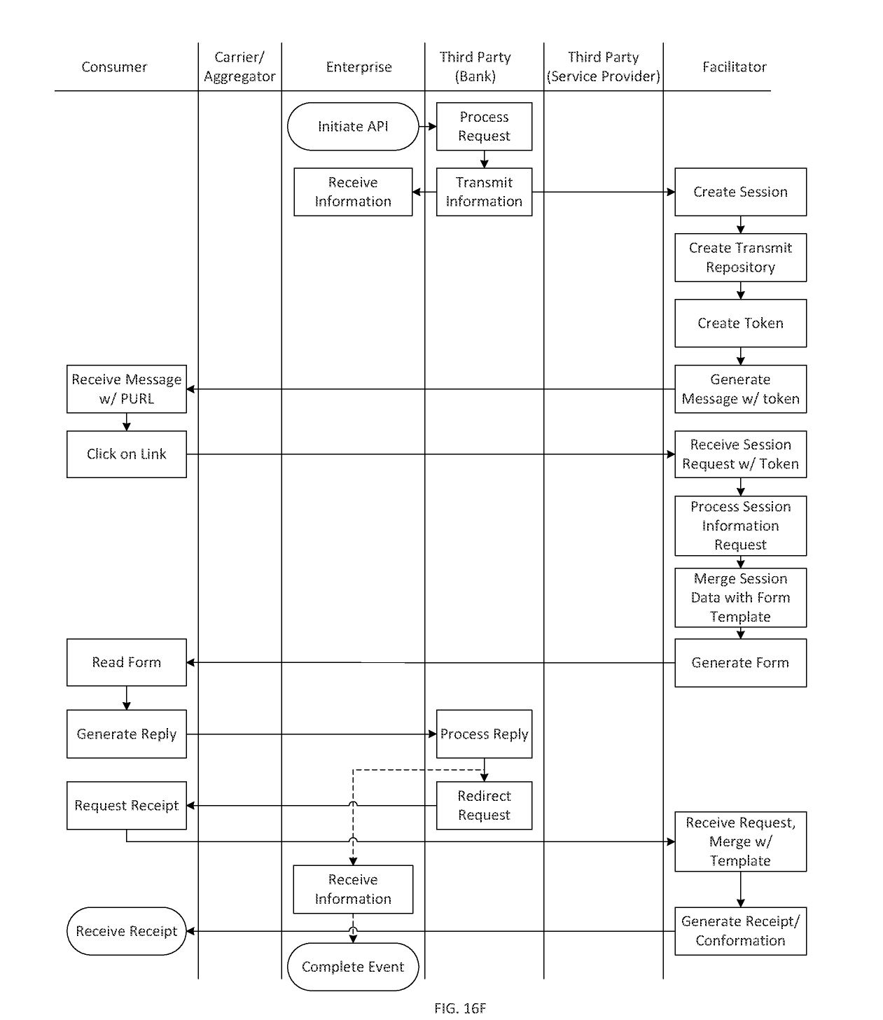

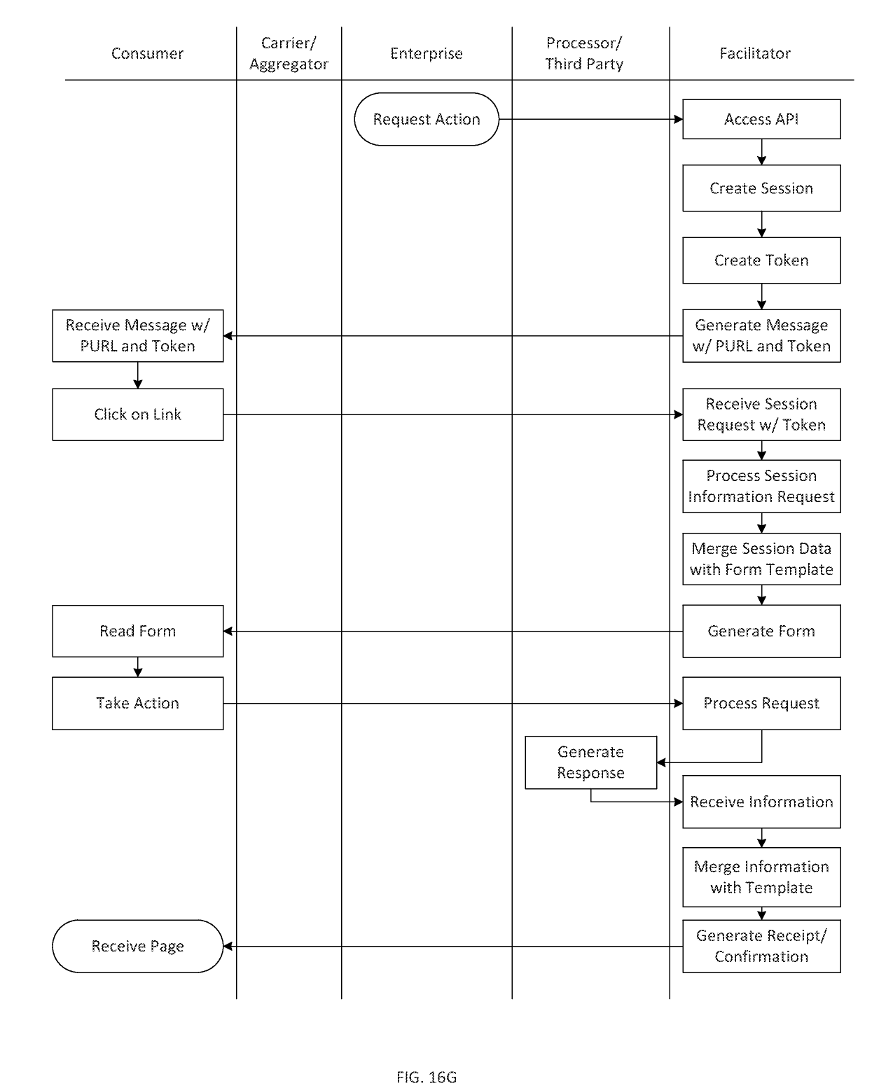

Referring to FIGS. 16A through 16E, transaction flow for transactions or interactions employing the facilitation system according to exemplary embodiments are shown; as shown, transactions or interactions may be designed or structured using the facilitation system in a flexible manner with consideration of the nature of the transaction or interaction, the participants/consumer, communication channels (preferred or available), information sharing and security, user authentication measures, data security management, sharing or allocation/distribution of functions and operations between entities, documentation and recordation of transactions, business analytics data availability and use, performance monitoring, use of standard forms/documents/files, session type, data management and storage, etc. For example, as shown in FIG. 16A, in the transaction or interaction with the consumer, the facilitator may use one or more communication channels such as mWeb (mobile web), mApp (application program operating on a mobile device), messaging (e.g. SMS, MMS or other message service), IVR (e.g. interactive voice response using telephony), e-mail communication, or other channels; the communication channel for a transaction may be selected by the consumer or by the enterprise or otherwise determined based upon need or availability. FIGS. 16B through 16E show transactions of various types and structure involving varying activities (e.g. processing and delivery of information, responses, session management, etc.) and varying levels of involvement of third-party entities. According to other exemplary embodiments, the nature and level of involvement of third parties in the transaction or interaction may be expanded (using the facilitation system, e.g. APIs, etc. as indicated in FIG. 5D) or contracted. According to any preferred embodiment, at least one entity will operate as facilitator with the functionality to facilitate the transaction or interaction between the consumer and the enterprise.

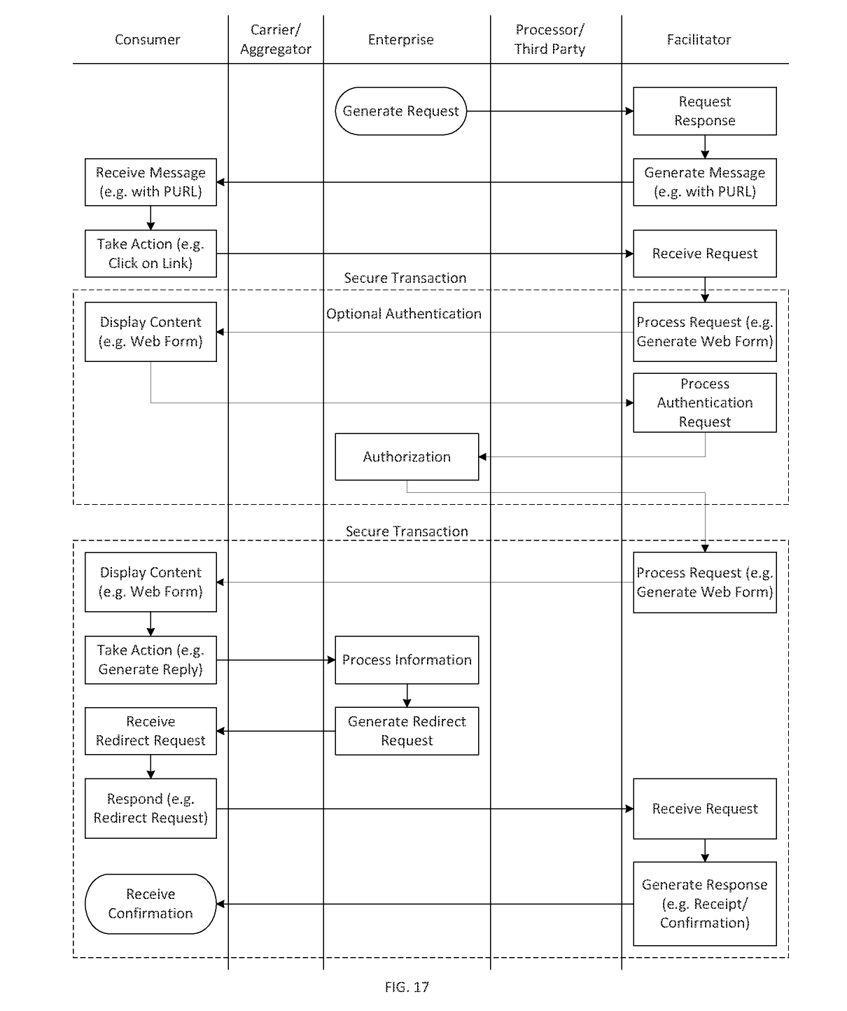

As shown in FIGS. 5D and 17, the facilitation system may be configured to provide for authentication, authorization and management of security of a transaction or interaction. According to any preferred embodiment, the system may be configured to use existing or conventional methods for secure transactions. As shown in FIGS. 5D and 15, for example, the facilitation system may for purposes of managing security of a transaction create a token or unique identifier of the transaction when a session is opened or created for a consumer; the token may then be used in the facilitation of the subsequent activities for or with the consumer until completion or termination of the transaction.

It is important to note that the construction and arrangement of the elements of the inventions as described in system and method and as shown in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, variations in the arrangement or sequence of process/method steps, operating conditions and arrangement of the preferred and other exemplary embodiments without departing from the spirit of the present inventions.

It is important to note that the system and method of the present inventions can comprise conventional technology (e.g. computing systems, telecommunication systems, networking technology, data storage, data transmission, data/file structures/formats, systems/software, application programs, mobile device technology, etc.) or any other applicable technology (present or future) that has the capability to perform the functions and processes/operations indicated in the FIGURES. All such technology is considered to be within the scope of the present inventions.

1. A system for conducting a transaction that is structured by a facilitator to be conducted between a merchant and a customer with a mobile device involving the interchange of a first set of information and a second set of information between the merchant and the customer comprising:
(a) a computing system operated by the facilitator that is configured to assemble data to be presented to the mobile device of the customer;
(b) a network connection configured to transmit the data to be presented on the mobile device of the customer;
wherein the first set of information comprises information relating to the customer;
wherein the second set of information comprises information relating to an account used by the customer;
wherein the data is presented to the mobile device of the customer by a message.

2. The system of claim 1 wherein the message comprises one of: text message, multi-media message, push notification, or mobile application initiated message.

3. The system of claim 1 wherein the message comprises a link to a web page that opens on the mobile device to present a form to be completed by the customer by the inclusion of the second set of information; and wherein the form comprises a link configured to have the form submitted to the merchant to facilitate the completion of the transaction so that the facilitator does not receive any of the second set of information.

4. The system of claim 1 wherein the message comprises at least one of a short message, a text message, a multimedia message, an SMS message, an MMS message, an electronic mail message, an e-mail message, a push message.

5. The system of claim 1 wherein the message comprises at least one of a link to an application to be operated on the mobile device, a web site, a web page to be presented on the mobile device, a web page configured to be presented on a mobile device, a file.

6. The system of claim 1 wherein the account used by the customer comprises at least one of a credit card account, a debit card account, a bank account, a check card account, an account with the merchant.

7. The system of claim 1 wherein the account used by the customer comprises an account linked to at least one of a credit card account or a bank account.

8. The system of claim 1 wherein the account used by the customer comprises a user account.

9. The system of claim 1 wherein the account used by the customer relates to a wire transfer.

10. The system of claim 1 wherein the first set of information comprises and identifier of the customer.

11. The system of claim 1 wherein the first set of information comprises data maintained by the facilitator to identify the customer.

12. A method of conducting a transaction that is structured by a facilitator to be conducted between a merchant and a customer with a mobile device involving the interchange of a first set of information and a second set of information between the merchant and the customer comprising:
(a) receiving a communication from the merchant to make a first communication to the customer;
(b) processing the communication from the merchant on a computing system to identify at least one customer;
(c) transmitting a communication to the mobile device of the customer relating to the first set of information;
(d) receiving a response from the mobile device of the customer;
(e) reviewing the response from the customer;
(f) providing a communication to the mobile device of the customer to that is configured to obtain from the customer a second set of information and to transmit upon approval by the customer the second set of information to the merchant to initiate the completion of the transaction;
(g) receiving a notification from the merchant relating to the status of the transaction; and
(h) transmitting a notification of the status of the transaction to the customer.

13. The method of claim 12 wherein the first set of information comprises information relating to the customer.

14. The method of claim 12 wherein the second set of information comprises information relating to an account used by the customer.

15. The method of claim 12 wherein the data is presented to the mobile device of the customer by a text message.

16. The method of claim 12 wherein the communication comprises a first communication to the customer that comprises a link to a web page that opens on the mobile device to present a form to be completed by the customer by the inclusion of the second set of information; and wherein the form comprises a link configured to have the form submitted to the merchant to facilitate the completion of the transaction so that the facilitator does not receive any of the second set of information.

17. The method of claim 12 wherein the first communication to the customer comprises a push notification.

18. The method of claim 12 wherein an application program runs on the mobile device to facilitate the transmission of at least a portion of the information to and from the customer.

19. The method of claim 18 wherein the application program is configured to operate on a mobile device as a mobile application.

20. The method of claim 12 wherein the first communication to the customer comprises a text message.

21. The method of claim 12 wherein the account used by the customer comprises a credit card account.

22. The method of claim 12 wherein the account used by the customer comprises a bank account.

23. The method of claim 12 wherein the first set of information comprises an identifier of the customer.

24. The method of claim 12 wherein the first set of information comprises data maintained by the facilitator to identify the customer.

25. The system of claim 1 wherein the facilitator comprises a primary facilitator and a secondary facilitator.

26. The system of claim 25 wherein the secondary facilitator comprises a third-party service provider.

27. A system for conducting a transaction that is structured by a facilitator to be conducted between a merchant and a customer with a mobile device involving the interchange of at least a first set of data and a second set of data between the merchant and the customer comprising:
a computing system operated by the facilitator that is configured to assemble data to be presented to the mobile device of the customer;
a network connection configured to transmit data to be presented on the mobile device of the customer;
wherein the first set of data comprises personal information relating to the customer;
wherein the second set of data comprises other information relating to the transaction;
wherein data is presented to the mobile device of the customer by a first type of communication;
wherein data is transmitted from the mobile device of the customer by a second type of communication;
wherein the first type of communication comprises at least one of (a) push communication; (b) text message; (c) SMS message; (d) MMS message; (e) electronic mail message;
wherein the second type of communication comprises at least one of (a) communication initiated by an application program operating on the mobile device; (b) text message; (c) SMS message; (d) MMS message; (e) electronic mail message; (f) communication of information submitted by a web page; (g) communication of information submitted by a web page configured for a mobile device; (h) communication of information submitted by transmission of a file; (i) communication of information into a form presented on the mobile device.

28. The system of claim 27 wherein the first set of data is transient.

29. The system of claim 27 wherein the second set of data is stored for at least a specified period of time after the transaction.

30. The system of claim 29 wherein the first set of data is deleted after the transaction.

31. The system of claim 30 wherein the first set of data is destroyed after a specified period of time after the transaction.

32. The system of claim 27 wherein the facilitator does not receive the first set of data.

33. The system of claim 27 wherein the facilitator receives the first set of data and the second set of data.

34. The system of claim 32 wherein the facilitator receives the second set of data.

35. The system of claim 27 wherein the transaction comprises at least one of (a) a banking transaction; (b) a financial transaction; (c) a wire transfer approval; (d) a payment collection; (e) a purchase; (f) an alert to the customer; (g) registration of the customer; (h) a retail transaction; (i) a transaction related to customer loyalty; (j) a medical transaction; (k) a reminder of an appointment; (l) a test or trial of a medication; (m) a test or trial involving the customer; (n) a notification; (o) a fee collection; (p) a service reminder; (q) a maintenance reminder; (r) a report on an account; (s) a telecommunications service; (t) a hospitality transaction; (u) an entertainment transaction; (v) a travel transaction; (w) a completion of an accommodation; (x) a confirmation of a reservation; (y) a reminder of a reservation; (z) a subscription; (aa) a fraud alert; (bb) a billing threshold alert; (cc) a credit card usage alert; (dd) a customer loyalty recognition transaction; (ee) a notice of a customer loyalty opportunity; (ff) a notice of a transaction that was initiated but that was not completed; (gg) a notice of a pending transaction that remains pending; (hh) a notice of a shopping cart that contains items to be purchased but that has been abandoned for a specified period of time; (ii) a notice of the contents of a shopping cart for a transaction; (jj) an account information message; (kk) scheduling or rescheduling of an appointment; (ll) scheduling of a service; (mm) refilling or replenishing an product; (nn) transacting with a pharmacy or health care provider; (oo) transacting with a service provider; (pp) informing of a completed transaction; (qq) completion of a service or product available for pick-up or delivery.

36. The system of claim 27 wherein the transaction comprises a shopping cart that has been abandoned by the customer and the data transmitted to the customer comprises a reminder of the shopping cart.

37. A system for configuring a transaction between a person using a mobile device and an enterprise that can involve a facilitator and a third party entity comprising:
(a) a computing system operated by the facilitator;
(b) at least one application program interface made available by the facilitator to the third party entity;
(c) data storage associated with the computing system for at least temporarily storing data related to the transaction;
(d) network connectivity from the computing system to the enterprise, to the third party entity and to the person using the mobile device;
wherein the facilitator also provides data files that can be presented to the mobile device for facilitating the transaction; and
wherein the facilitator provides information relating to the transaction to the enterprise after the transaction has been initiated.

38. The system of claim 37 wherein the transaction comprises at least one of (a) a banking transaction; (b) a financial transaction; (c) a wire transfer approval; (d) a payment collection; (e) a purchase; (f) an alert to the customer; (g) registration of the customer; (h) a retail transaction; (i) a transaction related to customer loyalty; (j) a medical transaction; (k) a reminder of an appointment; (l) a test or trial of a medication; (m) a test or trial involving the customer; (n) a notification; (o) a fee collection; (p) a service reminder; (q) a maintenance reminder; (r) a report on an account; (s) a telecommunications service; (t) a hospitality transaction; (u) an entertainment transaction; (v) a travel transaction; (w) a completion of an accommodation; (x) a confirmation of a reservation; (y) a reminder of a reservation; (z) a subscription; (aa) a fraud alert; (bb) a billing threshold alert; (cc) a credit card usage alert; (dd) a customer loyalty recognition transaction; (ee) a notice of a customer loyalty opportunity; (ff) a notice of a transaction that was initiated but that was not completed; (gg) a notice of a pending transaction that remains pending; (hh) a notice of a shopping cart that contains items to be purchased but that has been abandoned for a specified period of time; (ii) a notice of the contents of a shopping cart for a transaction; (jj) an account information message; (kk) scheduling or rescheduling of an appointment; (ll) scheduling of a service; (mm) refilling or replenishing an product; (nn) transacting with a pharmacy or health care provider; (oo) transacting with a service provider; (pp) informing of a completed transaction; (qq) completion of a service or product available for pick-up or delivery.

39. The system of claim 37 wherein the information provided to the enterprise comprises business analytics data.

40. The system of claim 37 wherein the third party entity comprises a credit card merchant.

41. The system of claim 38 wherein the third party entity comprises an entity to assist the facilitation of the transaction and wherein the entity facilitates the transaction through the application program interface of the facilitator.

42. The system of claim 37 wherein the application program interface comprises at least one of identifying the customer, authenticating the customer, managing the transaction.

43. The system of claim 37 wherein the transaction comprises the following steps: (a) receiving a message that initiates a transaction and requesting a first set of information; (b) providing a first set of information; (c) transmitting a communication to the customer to that is configured to obtain from the customer a second set of information and to transmit the second set of information to the merchant to initiate the completion of the transaction; (d) receiving a notification from the merchant relating to the status of the transaction; and (e) transmitting a notification of the status of the transaction to the customer.

44. The system of claim 37 wherein the transaction comprises a session initiated by the facilitator and wherein data for the session is managed by the facilitator and wherein the session comprises at least one interaction between the customer and the third party.

45. The system of claim 44 wherein the at least one interaction comprises a direct interaction between the customer and the third party using a network maintained by a telecommunications company.

46. The system of claim 37 wherein a telecommunications company provides network access for the transaction, the enterprise structures the transaction, the customer participates in the transaction, the facilitator facilitates the transaction, and the third party entity facilitates the transaction.

47. The system of claim 37 wherein the information comprises at least one of personally-identifiable information (PII), private health-care information (PHI), private credit information (PCI) or enterprise secure data (ESD).

48. The system of claim 38 where the transaction comprises a session managed by the facilitator, where the information comprises session data, and wherein the session data comprises personally-identifiable information that is maintained by the facilitator as transient data.

49. The system of claim 37 wherein the transaction comprises at least one session and the information comprises session data; wherein at least a portion of session data is transmitted by at least one communication channel selected from a list comprising push notification, messaging, text messaging, SMS, multimedia messaging, MMS, internet communication, mobile web communication, mWeb, application program communication, mobile application program, mApp, electronic mail, and e-mail.

50. The system of claim 49 wherein at least a portion of the session data is transient data that is stored in a database during the session; wherein the database comprises transient data for the session for at least one of (a) a specified use or (b) a specified period of time.
